(19) United States
(12) Patent Application Publication
(10) Pub. No.: US 2026/0178820 A1
(43) Pub. Date: Jun. 25, 2026

(54) METHOD AND APPARATUS FOR GENERATING TRAINING DATA AND TRAINING A MACHINE LEARNING ENGINE TO GENERATE A CONFIDENCE VALUE FOR AN ANNOTATED TEXT SPAN

(71) Applicant: Emtelligent Software Ltd., Vancouver (CA)

(72) Inventors: Anoop Dipesh SARKAR, Vancouver (CA); Logan Orion BORN, Calgary (CA)

(21) Appl. No.: 19/424,826

(22) Filed: Dec. 18, 2025

Related U.S. Application Data
(60) Provisional application No. 63/738,695, filed on Dec. 24, 2024.

(51) Int. Cl. G06F 40/169; G06F 40/247; G06N 3/0475; G06N 3/08

(52) U.S. Cl. CPC G06F 40/169; G06F 40/247; G06N 3/0475; G06N 3/08

(57) ABSTRACT

The present disclosure provides for a method apparatus for training and utilizing a machine learning model to generate a confidence value for an annotated text span that includes annotated text, a remainder, and a description, the machine learning model comprising at least a first classifier trained to generate a first value that indicates a first label of the text span a plausible or implausible, the first label associated with plausibility between the remainder of the text span and the description, and a second classifier trained to generate a second value that indicates a likelihood of a second label of the text span being plausible, the second label associated with a plausibility between the annotated text and the description.

### FIELD

The present disclosure relates generally to generating training data and training a machine learning engine to generate a confidence value for an annotated text span.

### BACKGROUND

In order to assist with processing and/or analysis of documents by computers, and in particular, large language models (LLMs), the contents of those documents are often annotated first prior to the processing and/or analysis. The annotations may then be used, for example, by the LLM to provide additional information about the content of the documents to assist the LLM in performing the analysis, such as summarizing the contents of the documents. Such annotations may be beneficial in improving the analysis that is performed by the LLM including, for example, in reducing “hallucinations” generated by the LLM.

Such annotations may be particular helpful for documents that relate to specific contexts that include technical language and knowledge such as, for example, medical, legal, or financial (e.g., accounting, tax) contexts. In such example contexts, the annotations may be based on standardized, context-specific codes or classifications that are related to the specific context, which context-specific codes are referred to generally as “ontology codes” in the present disclosure.

For example, in a medical context, the International Classification of Diseases version 10 Clinical Modification (ICD-10/ICD-10-CM), referred to herein as “ICD-10”, is the World Health Organization's (WHO) medical coding ontology which is the standard for used by health insurance companies for reimbursement of healthcare related expenses.

There are many different ways in which documents may be annotated based on a context-specific ontology, including, for example, rule-based string matching systems, neural network entity-linking models, and LLMs or other language model that is fine-tuned to the particular context of the documents. The annotations typically involve the system identifying a span of text in the document, such as a sentence, and linking a term or phrase in that span of text to a concept included in the ontology. The annotated data may then include the span of text, an indication indicating the term or phrase that is annotated, and a concept identifier for the concept from the ontology that the term or phrase is linked to. The concept identifier may be an ontology code, the natural language name of the concept, and/or a definition of the concept.

However, the annotations generated are not always correct and a challenge exists in determining a reliability of the annotations that are included in annotation data that is associated with a document. Because of the volume of annotation data that typically exists in real world situations, having a knowledgeable human review the annotations for accuracy is not feasible, and would erode any benefit provided by having a computer generate the annotations.

A standard approach to determining a confidence estimation of an annotation in annotation data is to measure a probability mass assigned by the model that generated the annotation to the most likely concept identifier, and to directly use this quantity as a measure of the model's confidence, where a higher probability is taken to mean a more confident assignment to the given concept. This quantity may also be transformed by some process, to smooth the probability distribution or to re-weight concepts before measuring the model's confidence.

However, a drawback of this approach is that the model must be preconfigured to output the probability mass, which may require modifications to the an existing model, which may not always be possible, and may require information of the inner state of the model, which may not always be available. Additionally, often annotation data may be available from a model that does not include such probability mass output, and in which the model that generated the data may not be known.

Improvements to computer-implemented methods for assessing the reliability of annotation data are desired.

### SUMMARY

According to an aspect of an embodiment, the present disclosure provides a method of training a machine learning model, the method includes for each concept of a set of concept of an ontology, obtaining an initial sentence that includes a synonym associated with the concept, generating, based on the initial sentence: a first generated sentence by replacing the synonym in the initial sentence with a different synonym associated with the concept, annotating the first generated sentence as an instance of the concept, a second generated sentence by replacing the synonym in the initial sentence with a different synonym associated with the concept and annotating the second generated sentence as an instance of a concept different than the concept, a third generated sentence by replacing the synonym with a synonym associated with a different concept that is different than the concept and annotating the third annotated sentence as an instance of the concept, a fourth generated sentence by replacing the synonym in the initial sentence with a synonym associated with a different concept that is different the concept and annotating the fourth generated sentence as an instance of the different concept, and a fifth generated sentence by replacing the synonym in the initial sentence with a different synonym associated with the concept and annotating the fifth generated sentence as an instance of a concept that is different than the concept, generating, for each of the generated sentences, a first label associated with a remainder-concept plausibility, a second label associated with a synonym-concept plausibility, and third label associated with a remainder-synonym plausibility such that: for the first generated sentence, the first, second, and third labels indicate plausible, for the second generated sentence, the third label indicates plausible, and the first and second labels indicate implausible, for the third generated sentence, the first label indicates plausible, and the second and third labels indicate implausible, for the fourth generated sentence, the second label indicates plausible and the first and third labels indicate implausible, and for the fifth generated sentence, the first, second, and third labels indicate implausible, generating training data that comprises the generated sentences and the associated first, second, and third labels for each of the concept of the set of concepts, and training, utilizing the training data, the machine learning model to determine the first label and the second label as plausible or implausible for an input annotated text span.

In an example, for each concept of the set of concepts, obtaining the initial sentence includes obtaining a synonym associated with the concept from a set of synonyms associated with the concept, and transmitting a request to a generative model to generate an example sentence that includes the obtained synonym, receiving, from the generative model, the example sentence, wherein the received example sentence is the initial sentence.

In an example, training the machine learning model includes training a first classifier of the machine learning model to determine whether the first label of an input annotated text span is plausible or implausible, and training a second classifier of the machine learning model to determine whether the second label of an input annotated text span is plausible or implausible.

In an example, training the machine learning model includes training the machine learning model to determine the third label as plausible or implausible for an input annotated text span by training a third classifier of the machine learning model to determine whether the third label of an input annotated text span is plausible or implausible.

In an example, generating the training data includes, for each generated sentence obtaining a description of the synonym included in the generated sentence, separating the generated sentence into the synonym of the generated sentence and a remainder of the generated sentence, generating a training data element for the generated sentence comprising the synonym, the remainder of the generated sentence, and the description of the synonym.

In an example, the description is one of a definition of the synonym, a concept identifier of the concept of the ontology that is associated with the synonym, or a natural language name for the concept of the ontology that is associated with the synonym.

In an example, obtaining the description includes instructing a generative machine learning model to generate a description or definition of the synonym, or generate a description or definition of a natural language name of a concept that is associated with the synonym, and receiving, from the generative machine learning model, the generated description or definition.

In an example, generating the training data element for the generated sentence includes replacing the synonym in the remainder with a mask token, inserting delimitators between the remainder, the synonym, and the description to generate a templated training data element, and generating, utilizing an embedding function, a vector representation of the templated training data element.

In an example, generating the training data element for the generated sentence includes generating, utilizing an embedding function: a first vector representation of the remainder, a second vector representation of the synonym, and a third vector representation of the description, wherein training the machine learning model includes training a first classifier of the machine learning model to determine whether the first label of an input annotated text span is plausible or implausible utilizing only the first and third vector representations of the training data, and training a second classifier of the machine learning model to determine whether the second label of an input annotated text span is plausible or implausible utilizing only the second and third vector representations of the training data.

In an example, training the machine learning model further includes training a third classifier of the machine learning model to determine whether the third label of an input annotated text span is plausible or implausible utilizing only the first and second vector representations of the training data.

According to another aspect of an embodiment, the present disclosure provides a method for a machine learning system, the method including obtaining annotation data that includes one or more annotated text spans, each annotation text span including a text span and a description, the text span including annotated text and a remainder comprising text of the text span other than annotated text, wherein the description is associated with a concept of an ontology that is linked to the annotated text, for each of the one or more annotated text spans: inputting the annotated text span into a machine learning model, the machine learning model including: a first classifier trained to generate a first value that indicates a first label of the text span a plausible or implausible, the first label associated with plausibility between the remainder of the text span and the description, and a second classifier trained to generate a second value that indicates a likelihood of a second label of the text span being plausible, the second label associated with a plausibility between the annotated text and the description, receiving, from the machine learning model, the first value and the second value, determining, based on the first value and the second value, a confidence value associated of the annotated text span, and updating the annotation data to include the confidence value for the annotated text span.

In an example, the machine learning model further includes a third classifier trained to generate a third value that indicates a likelihood of a third label of the text span being plausible, the third label associated with a plausibility between the remainder and the annotated text, the method further includes receiving the third value and the third accuracy value.

In an example, the method further includes replacing the annotated text in the text span with a mask token, generating a templated text span that includes the remainder, the mask token, the annotated text, and the description separated by delimiters, and generating, utilizing an embedding function, a vector representation of the templated text span, wherein inputting the obtained text span into the machine learning model comprises inputting the vector representation.

In an example, the method further includes generating, utilizing an embedding function a first vector representation of the remainder of the text span, a second vector representation of the annotated text, and a third vector representation of the description, wherein inputting the annotated text span into the machine learning model comprises inputting the first, second, and third vector representations, and wherein the first classifier is trained to generate the first value based on the first and third vector representations, and the second classifier is trained to generate the second value based on the second and third vector representations.

In an example, the machine learning model further comprises a third classifier trained to generate a third value based on the first and second vector representations, the third value indicates a likelihood of a third label of the text span being plausible, the third label associated with a plausibility between the remainder and the annotated text, the method further comprising receiving the third value.

In an example, the confidence value is determined as:

$$confidence value = \frac{A + C}{2}$$

where A is the first value, and C is the second value.

In an example, the first classifier is trained to generate a first accuracy value indicating an expected accuracy of the first value, and the second classifier is trained to generate a second accuracy value indicating an expected accuracy of the second value, the method further includes receiving the first accuracy value and the second accuracy value, and wherein the confidence value is determined as:

$$confidence value = A \times C \times E$$

where A is the first value, and C is the second value, and E is the smaller of the first and second accuracy values.

In an example, the first classifier is trained to generate a first accuracy value indicating an expected accuracy of the first value, and the second classifier is trained to generate a second accuracy value indicating an expected accuracy of the second value, the method further includes receiving the first accuracy value and the second accuracy value, and wherein the confidence value is determined as:

$$confidence value = \frac{A + C}{2} \times E$$

where A is the first value, and C is the second value, and E is the smaller of the first and second accuracy values.

In an example, determining the confidence value based on the first value and the second value comprises weighing the first and second values.

In an example, obtaining the annotation data comprises obtaining the description associated a concept linked to the annotation text.

In an example, the method further includes determining a first set of annotated text spans having a confidence value that meets a threshold, and removing the first set of annotated text spans from the updated annotation data to generate filtered annotated data.

According to another aspect of an embodiment, the present disclosure provides a machine learning engine including a processor, and a memory storing processor executable instructions for a machine learning model executable by the processor, wherein the machine learning model is trained utilizing any of the example methods for training the machine learning model disclosed herein.

According to another aspect of an embodiment, the present disclosure provides an apparatus for training a machine learning model, the apparatus including a processor, and a memory storing processor executable instructions executable by the processor to cause the process to, for each concept of a set of concept of an ontology, obtain an initial sentence that includes a synonym associated with the concept, generate, based on the initial sentence, a first generated sentence by replacing the synonym in the initial sentence with a different synonym associated with the concept, annotating the first generated sentence as an instance of the concept, a second generated sentence by replacing the synonym in the initial sentence with a different synonym associated with the concept and annotating the second generated sentence as an instance of a concept different than the concept, a third generated sentence by replacing the synonym with a synonym associated with a different concept that is different than the concept and annotating the third annotated sentence as an instance of the concept, a fourth generated sentence by replacing the synonym in the initial sentence with a synonym associated with a different concept that is different the concept and annotating the fourth generated sentence as an instance of the different concept, a fifth generated sentence by replacing the synonym in the initial sentence with a different synonym associated with the concept and annotating the fifth generated sentence as an instance of a concept that is different than the concept, generate, for each of the generated sentences, a first label associated with a remainder-concept plausibility, a second label associated with a synonym-concept plausibility, and third label associated with a remainder-synonym plausibility such that for the first generated sentence, the first, second, and third labels indicate plausible, for the second generated sentence, the third label indicates plausible, and the first and second labels indicate implausible, for the third generated sentence, the first label indicates plausible, and the second and third labels indicate implausible, for the fourth generated sentence, the second label indicates plausible and the first and third labels indicate implausible, and for the fifth generated sentence, the first, second, and third labels indicate implausible, generate training data that comprises the generated sentences and the associated first, second, and third labels for each of the concept of the set of concepts, and train, utilizing the training data, the machine learning model to determine the first label and the second label as plausible or implausible for an input annotated text span.

In an example, for each concept of the set of concepts, the instructions to cause the processor to obtain the initial sentence comprises instructions that, when executed by the processor, cause the processor to obtain a synonym associated with the concept from a set of synonyms associated with the concept, and transmit a request to a generative model to generate an example sentence that includes the obtained synonym, receive, from the generative model, the example sentence, wherein the received example sentence is the initial sentence.

In an example, the instructions to cause the processor to train the machine learning model comprises instructions that, when executed by the processor, cause the processor to train a first classifier of the machine learning model to determine whether the first label of an input annotated text span is plausible or implausible, and train a second classifier of the machine learning model to determine whether the second label of an input annotated text span is plausible or implausible.

In an example, the instructions to cause the processor to train the machine learning model comprises instructions that, when executed by the processor, cause the processor to train the machine learning model to determine the third label as plausible or implausible for an input annotated text span by training a third classifier of the machine learning model to determine whether the third label of an input annotated text span is plausible or implausible.

In an example, the instructions to cause the processor to generate the training data comprises instructions that, when executed by the processor, cause the process to, for each generated sentence obtain a description of the synonym included in the generated sentence, separate the generated sentence into the synonym of the generated sentence and a remainder of the generated sentence, generate a training data element for the generated sentence comprising the synonym, the remainder of the generated sentence, and the description of the synonym.

In an example, the description is one of a definition of the synonym, a concept identifier of the concept of the ontology that is associated with the synonym, or a natural language name for the concept of the ontology that is associated with the synonym.

In an example, the instructions to cause the processor to obtain the description comprises instructions that, when executed by the processor, causes the processor to instruct a generative machine learning model to generate a description or definition of the synonym, or generate a description or definition of a natural language name of a concept that is associated with the synonym, and receive, from the generative machine learning model, the generated description or definition.

In an example, the instruction to cause the processor to generate the training data element for the generated sentence comprises instructions that, when executed by the processor, cause the processor to replace the synonym in the remainder with a mask token, insert delimitators between the remainder, the synonym, and the description to generate a templated training data element, and generate, utilizing an embedding function, a vector representation of the templated training data element.

In an example, the instructions to cause the processor to generate the training data element for the generated sentence comprises instructions that, when executed by the processor, cause the processor to generate, utilizing an embedding function a first vector representation of the remainder, a second vector representation of the synonym, and a third vector representation of the description, wherein the instructions to cause the processor to train the machine learning model comprises instructions that, when executed by the processor, cause the processor to train a first classifier of the machine learning model to determine whether the first label of an input annotated text span is plausible or implausible utilizing only the first and third vector representations of the training data, and train a second classifier of the machine learning model to determine whether the second label of an input annotated text span is plausible or implausible utilizing only the second and third vector representations of the training data.

In an example, the instructions to cause the processor to train the machine learning model comprises instructions that, when executed by the processor, further cause the processor to train a third classifier of the machine learning model to determine whether the third label of an input annotated text span is plausible or implausible utilizing only the first and second vector representations of the training data.

According to another aspect of an embodiment, the present disclosure provides an apparatus comprising a processor, and a memory storing processor executable instructions executable by the processor to cause the process to obtain annotation data that includes one or more annotated text spans, each annotation text span including a text span and a description, the text span including annotated text and a remainder comprising text of the text span other than annotated text, wherein the description is associated with a concept of an ontology that is linked to the annotated text, for each of the one or more annotated text spans input the annotated text span into a machine learning model, the machine learning model comprising a first classifier trained to generate a first value that indicates a first label of the text span a plausible or implausible, the first label associated with plausibility between the remainder of the text span and the description, and a second classifier trained to generate a second value that indicates a likelihood of a second label of the text span being plausible, the second label associated with a plausibility between the annotated text and the description, receive, from the machine learning model, the first value and the second value, determine, based on the first value and the second value, a confidence value associated of the annotated text span, and update the annotation data to include the confidence value for the annotated text span.

In an example, the machine learning model further includes a third classifier trained to generate a third value that indicates a likelihood of a third label of the text span being plausible, the third label associated with a plausibility between the remainder and the annotated text, the instructions further comprising instructions that, when executed by the processor, cause the processor to receive the third value and the third accuracy value.

In an example, the instructions further comprise instructions that, when executed by the processor, cause the processor to replace the annotated text in the text span with a mask token, generate a templated text span that includes the remainder, the mask token, the annotated text, and the description separated by delimiters, and generate, utilizing an embedding function, a vector representation of the templated text span, wherein the instructions to cause the processor to input the obtained text span into the machine learning model comprises instructions that, when executed by the processor, cause the processor to input the vector representation.

In an example, the instructions further comprise instructions that, when executed by the processor, cause the processor to generate, utilizing an embedding function a first vector representation of the remainder of the text span, a second vector representation of the annotated text, and a third vector representation of the description, wherein the instructions that cause the processor to input the annotated text span into the machine learning model comprises instructions that, when executed by the processor, cause the processor to input the first, second, and third vector representations, and wherein the first classifier is trained to generate the first value based on the first and third vector representations, and the second classifier is trained to generate the second value based on the second and third vector representations.

In an example, the machine learning model further comprises a third classifier trained to generate a third value based on the first and second vector representations, the third value indicates a likelihood of a third label of the text span being plausible, the third label associated with a plausibility between the remainder and the annotated text, the instructions further comprising instructions that, when executed by the processor, cause the processor to receive the third value.

In an example, the confidence value is determined as:

$$confidence value = \frac{A + C}{2}$$

where A is the first value, and C is the second value.

In an example, the first classifier is trained to generate a first accuracy value indicating an expected accuracy of the first value, and the second classifier is trained to generate a second accuracy value indicating an expected accuracy of the second value, the instructions further comprising instructions that, when executed by the processor, cause the processor to receive the first accuracy value and the second accuracy value, and wherein the confidence value is determined as:

$$confidence value = A \times C \times E$$

where A is the first value, and C is the second value, and E is the smaller of the first and second accuracy values.

In an example, the first classifier is trained to generate a first accuracy value indicating an expected accuracy of the first value, and the second classifier is trained to generate a second accuracy value indicating an expected accuracy of the second value, the instructions further comprising instructions that, when executed by the processor, cause the processor to receive the first accuracy value and the second accuracy value, and wherein the confidence value is determined as:

$$confidence value = \frac{A + C}{2} \times E$$

where A is the first value, and C is the second value, and E is the smaller of the first and second accuracy values.

In an example, the instruction that cause the processor to determine the confidence value based on the first value and the second value comprises instructions that, when executed by the processor, cause the processor to weigh the first and second values.

In an example, the instructions that cause the processor to obtain the annotation data comprises instructions that, when executed by the processor, cause the processor to obtain the description associated a concept linked to the annotation text.

In an example, the instructions further comprising instructions that, when executed by the processor, cause the processor to determine a first set of annotated text spans having a confidence value that meets a threshold, and remove the first set of annotated text spans from the updated annotation data to generate filtered annotated data.

According to another aspect of an embodiment, the present disclosure provides a non-transitory computer-readable medium having stored thereon computer-readable instructions for an apparatus for training a machine leaning model that, when executed by a processor, cause the processor to, for each concept of a set of concept of an ontology, obtain an initial sentence that includes a synonym associated with the concept, generate, based on the initial sentence, a first generated sentence by replacing the synonym in the initial sentence with a different synonym associated with the concept, annotating the first generated sentence as an instance of the concept, a second generated sentence by replacing the synonym in the initial sentence with a different synonym associated with the concept and annotating the second generated sentence as an instance of a concept different than the concept, a third generated sentence by replacing the synonym with a synonym associated with a different concept that is different than the concept and annotating the third annotated sentence as an instance of the concept, a fourth generated sentence by replacing the synonym in the initial sentence with a synonym associated with a different concept that is different the concept and annotating the fourth generated sentence as an instance of the different concept, a fifth generated sentence by replacing the synonym in the initial sentence with a different synonym associated with the concept and annotating the fifth generated sentence as an instance of a concept that is different than the concept, generate, for each of the generated sentences, a first label associated with a remainder-concept plausibility, a second label associated with a synonym-concept plausibility, and third label associated with a remainder-synonym plausibility such that for the first generated sentence, the first, second, and third labels indicate plausible, for the second generated sentence, the third label indicates plausible, and the first and second labels indicate implausible, for the third generated sentence, the first label indicates plausible, and the second and third labels indicate implausible, for the fourth generated sentence, the second label indicates plausible and the first and third labels indicate implausible, and for the fifth generated sentence, the first, second, and third labels indicate implausible, generate training data that comprises the generated sentences and the associated first, second, and third labels for each of the concept of the set of concepts, and train, utilizing the training data, the machine learning model to determine the first label and the second label as plausible or implausible for an input annotated text span.

In an example, for each concept of the set of concepts, the instructions to cause the processor to obtain the initial sentence comprises instructions that, when executed by the processor, cause the processor to obtain a synonym associated with the concept from a set of synonyms associated with the concept, and transmit a request to a generative model to generate an example sentence that includes the obtained synonym, receive, from the generative model, the example sentence, wherein the received example sentence is the initial sentence.

In an example, the instructions to cause the processor to train the machine learning model comprises instructions that, when executed by the processor, cause the processor to train a first classifier of the machine learning model to determine whether the first label of an input annotated text span is plausible or implausible, and train a second classifier of the machine learning model to determine whether the second label of an input annotated text span is plausible or implausible.

In an example, the instructions to cause the processor to train the machine learning model comprises instructions that, when executed by the processor, cause the processor to train the machine learning model to determine the third label as plausible or implausible for an input annotated text span by training a third classifier of the machine learning model to determine whether the third label of an input annotated text span is plausible or implausible.

In an example, the instructions to cause the processor to generate the training data comprises instructions that, when executed by the processor, cause the process to, for each generated sentence obtain a description of the synonym included in the generated sentence, separate the generated sentence into the synonym of the generated sentence and a remainder of the generated sentence, generate a training data element for the generated sentence comprising the synonym, the remainder of the generated sentence, and the description of the synonym.

In an example, the description is one of a definition of the synonym, a concept identifier of the concept of the ontology that is associated with the synonym, or a natural language name for the concept of the ontology that is associated with the synonym.

In an example, the instructions to cause the processor to obtain the description comprises instructions that, when executed by the processor, causes the processor to instruct a generative machine learning model to generate a description or definition of the synonym, or generate a description or definition of a natural language name of a concept that is associated with the synonym, and receive, from the generative machine learning model, the generated description or definition.

In an example, the instruction to cause the processor to generate the training data element for the generated sentence comprises instructions that, when executed by the processor, cause the processor to replace the synonym in the remainder with a mask token, insert delimitators between the remainder, the synonym, and the description to generate a templated training data element, and generate, utilizing an embedding function, a vector representation of the templated training data element.

In an example, the instructions to cause the processor to generate the training data element for the generated sentence comprises instructions that, when executed by the processor, cause the processor to generate, utilizing an embedding function a first vector representation of the remainder, a second vector representation of the synonym, and a third vector representation of the description, wherein the instructions to cause the processor to train the machine learning model comprises instructions that, when executed by the processor, cause the processor to train a first classifier of the machine learning model to determine whether the first label of an input annotated text span is plausible or implausible utilizing only the first and third vector representations of the training data, and train a second classifier of the machine learning model to determine whether the second label of an input annotated text span is plausible or implausible utilizing only the second and third vector representations of the training data.

In an example, the instructions to cause the processor to train the machine learning model comprises instructions that, when executed by the processor, further cause the processor to train a third classifier of the machine learning model to determine whether the third label of an input annotated text span is plausible or implausible utilizing only the first and second vector representations of the training data.

According to another aspect of an embodiment, the present disclosure provides a non-transitory computer-readable medium having stored thereon computer-readable instructions for an apparatus for training a machine leaning model that, when executed by a processor, cause the processor to obtain annotation data that includes one or more annotated text spans, each annotation text span including a text span and a description, the text span including annotated text and a remainder comprising text of the text span other than annotated text, wherein the description is associated with a concept of an ontology that is linked to the annotated text, for each of the one or more annotated text spans input the annotated text span into a machine learning model, the machine learning model comprising a first classifier trained to generate a first value that indicates a first label of the text span a plausible or implausible, the first label associated with plausibility between the remainder of the text span and the description, and a second classifier trained to generate a second value that indicates a likelihood of a second label of the text span being plausible, the second label associated with a plausibility between the annotated text and the description, receive, from the machine learning model, the first value and the second value, determine, based on the first value and the second value, a confidence value associated of the annotated text span, and update the annotation data to include the confidence value for the annotated text span.

In an example, the machine learning model further includes a third classifier trained to generate a third value that indicates a likelihood of a third label of the text span being plausible, the third label associated with a plausibility between the remainder and the annotated text, the instructions further comprising instructions that, when executed by the processor, cause the processor to receive the third value and the third accuracy value.

In an example, the instructions further comprise instructions that, when executed by the processor, cause the processor to replace the annotated text in the text span with a mask token, generate a templated text span that includes the remainder, the mask token, the annotated text, and the description separated by delimiters, and generate, utilizing an embedding function, a vector representation of the templated text span, wherein the instructions to cause the processor to input the obtained text span into the machine learning model comprises instructions that, when executed by the processor, cause the processor to input the vector representation.

In an example, the instructions further comprise instructions that, when executed by the processor, cause the processor to generate, utilizing an embedding function a first vector representation of the remainder of the text span, a second vector representation of the annotated text, and a third vector representation of the description, wherein the instructions that cause the processor to input the annotated text span into the machine learning model comprises instructions that, when executed by the processor, cause the processor to input the first, second, and third vector representations, and wherein the first classifier is trained to generate the first value based on the first and third vector representations, and the second classifier is trained to generate the second value based on the second and third vector representations.

In an example, the machine learning model further comprises a third classifier trained to generate a third value based on the first and second vector representations, the third value indicates a likelihood of a third label of the text span being plausible, the third label associated with a plausibility between the remainder and the annotated text, the instructions further comprising instructions that, when executed by the processor, cause the processor to receive the third value.

In an example, the confidence value is determined as:

$$confidence value = \frac{A + C}{2}$$

where A is the first value, and C is the second value.

In an example, the first classifier is trained to generate a first accuracy value indicating an expected accuracy of the first value, and the second classifier is trained to generate a second accuracy value indicating an expected accuracy of the second value, the instructions further comprising instructions that, when executed by the processor, cause the processor to receive the first accuracy value and the second accuracy value, and wherein the confidence value is determined as:

$$confidence value = A \times C \times E$$

where A is the first value, and C is the second value, and E is the smaller of the first and second accuracy values.

In an example, the first classifier is trained to generate a first accuracy value indicating an expected accuracy of the first value, and the second classifier is trained to generate a second accuracy value indicating an expected accuracy of the second value, the instructions further comprising instructions that, when executed by the processor, cause the processor to receive the first accuracy value and the second accuracy value, and wherein the confidence value is determined as:

$$confidence value = \frac{A + C}{2} \times E$$

where A is the first value, and C is the second value, and E is the smaller of the first and second accuracy values.

In an example, the instruction that cause the processor to determine the confidence value based on the first value and the second value comprises instructions that, when executed by the processor, cause the processor to weigh the first and second values.

In an example, the instructions that cause the processor to obtain the annotation data comprises instructions that, when executed by the processor, cause the processor to obtain the description associated a concept linked to the annotation text.

In an example, the instructions further comprising instructions that, when executed by the processor, cause the processor to determine a first set of annotated text spans having a confidence value that meets a threshold, and remove the first set of annotated text spans from the updated annotation data to generate filtered annotated data.

The term “non-transitory,” as used herein, is a limitation of the medium itself (i.e., tangible, not a signal) as opposed to a limitation on data storage persistency (e.g., RAM vs. ROM).

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a schematic diagram showing a system in accordance with an aspect of an embodiment.

FIG. 2 a flowchart showing a method for generating training data and training a machine learning model in accordance with an example embodiment.

FIG. 3 is a schematic diagram showing a system in accordance with another aspect of an embodiment.

FIG. 4 a flowchart showing a method for updating annotated data in accordance with an example embodiment.

FIG. 5 is a schematic diagram showing components of one or more of the example embodiments.

### DETAILED DESCRIPTION

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

Generally, the present disclosure provides a method and apparatus for training a machine learning model to evaluate annotation data in order to determine a confidence value that is associate with the annotation data. The confidence value indicates the plausibility of the concept to the text in an annotated text span. The present disclosure also provides a method and apparatus for determining a confidence value for annotated utilizing the output a trained machine learning model, and updating the annotated data to include the confidence value. The confidence value may then be utilized to, for example, filter the annotation data by, for example, removing annotation data for which the confidence value is less than a threshold value. This may result in “cleaner”, more reliable annotation data that results in later systems that utilize the annotation data for, for example, processing and/or analyzing the contents of documents associated with the annotations, to generate more accurate outputs and analyses, resulting in improvements to the overall computer system. Additionally, the annotation data that is identified as having a confidence value that is less than a threshold value may be utilized to improve the model that generated the annotation data such that, over time, the model generates more accurate annotation data, thereby resulting in an improvement in the overall computer system.

The confidence value is determined in accordance with the present disclosure in a way that does not require any modification to the model utilized to generate the annotation data, or require any information regarding the inner state of the model, overcoming at least some of the limitations referred to previously.

In the present disclosure, annotated data refers to any data that includes a span of text, and some concept from an ontology that is linked to some or all of the text in that span of text. Annotation data may include one or more annotated spans of text that includes a span of text, and some form of identifier to a concept from an ontology that the span of text is linked to. The span of text may include annotated text, which is text that is indicated to be linked to the concept, and a remainder, which is the portion of the span of test that is not the annotated text. The annotation may be any suitable indication of the concept that is linked to the annotated text and may include, for example, a concept identifier, such as the code included in the ontology for the concept, the natural language name of the concept, and/or a description of the concept.

References to a “machine learning model” may be understood to be references to a machine learning engine that implements the machine learning model. For example, the machine learning engine may comprise a processor and a memory storing instructions that are executed by the processor to execute and/or implement the machine learning model. The machine learning engine may be combined with, or separate from, other processors and/or computer elements disclosed herein.

In a first aspect of the present disclosure, a method and apparatus for generating training data and training a machine learning model having multiple classifiers is disclosed. First, a set of concept identifiers are obtained for an ontology from a database. For each identifier, a set of synonymous phrases which may stand for that concept in a body of text may be obtained, either from the ontology data base, or generated by a generative model or other large language model (LLM). For each concept identifier, the user then samples a particular one of these synonyms, for example by selecting on of the synonyms random. For each synonym thus sampled, the user then queries a LLM or other generative model to produce an initial sentence containing the given synonym. This yields a dataset of initial sentences for the obtained concepts.

Then, for each initial sentence, a set generated sentences are generated according to a procedure. In an example procedure, five generated sentences are generated as follows:

The original synonym is replaced with a distinct synonym sampled at random from the set of known synonyms for the original concept to generate a first generated sentence. This first generated sentence is annotated as being an instance of the original concept. This first generated sentence may be labelled as having a plausible remainder/synonym pairing, plausible remainder/concept pairing, and plausible synonym/concept pairing, where remainder refers to the portion of a sentence that is other than the synonym, or in other cases, the term or term or phrase that is linked to the concept associated with the sentence.

The original synonym is replaced with a distinct synonym sampled at random from the set of known synonyms for the original concept to generate a second generated sentence. This second generated sentence is intentionally erroneously annotated as being an instance of a different concept sampled at random from the set of known concepts. This second generated sentence is labelled as having a plausible remainder/synonym pairing, implausible remainder/concept pairing, and implausible synonym/concept pairing.

The original synonym is replaced with a synonym of a different concept sampled at random from the set of known concepts to generate a third generated sentence. The third generated sentence is intentionally erroneously annotated as being an instance of the original concept. The third generated sentence is labelled as having an implausible remainder/synonym pairing, plausible remainder/concept pairing, and implausible synonym/concept pairing.

The original synonym is replaced with a synonym of a different concept sampled at random from the set of known concepts to generate a fourth generated sentence. The fourth generated sentence is annotated as being an instance of the concept that was just sampled, so that the synonym and concept match one another but neither is expected to be plausible in context of the remainder of the fourth generated sentence. The fourth generated sentence is labelled as having an implausible remainder/synonym pairing, implausible remainder/concept pairing, and plausible synonym/concept pairing.

The original synonym is replaced with a synonym of a different concept sampled at random from the set of known concepts to generate a fifth generated sentence. The fifth generated sentence is intentionally erroneously annotated as being an instance of a different concept sampled at random from the set of known concepts. The fifth generated sentence is labelled as having an implausible remainder/synonym pairing, implausible remainder/concept pairing, and implausible synonym/concept pairing.

The first, second, third, fourth, and fifth generated sentences, together with their annotations and labels, generated for the initial sentences of each of the identified concept identifiers of the ontology, form a set of training data. According to one embodiment, this training data is utilized to train a machine learning model comprised of three classifiers that are each trained together, utilizing the training data, to predict the plausibility of a respective one of the remainder/synonym pairing, the remainder/concept pairing, or the synonym/concept pairing of an annotated text span.

In this manner, the evaluation of the plausibility an annotated text span, which is later utilized to determine a confidence value of the annotation, is decomposed into three distinct subtasks, entailing three pairwise comparisons between different aspects of a particular annotated text span input. This tripartite decomposition of the task breaks a single, complex, and more abstract prediction or determination of whether a given annotation is correct, into multiple discrete, simple and well-defined predictions that are more amenable to model independently, e.g., as independent classifiers within an overall machine learning model. Additionally, tripartite decomposition may facilitate the machine learning model performing multi-task learning, whereby the machine learning model is trained to make multiple distinct, but related, predictions or determinations, rather than a singular prediction. The use of multi-task learning may improve performance of the machine learning model by “inductive transfer” between the discrete prediction or determination tasks. Inductive learning to behaviors that are learned to be helpful for performing one task being applied to other tasks to improve the performance of those other tasks.

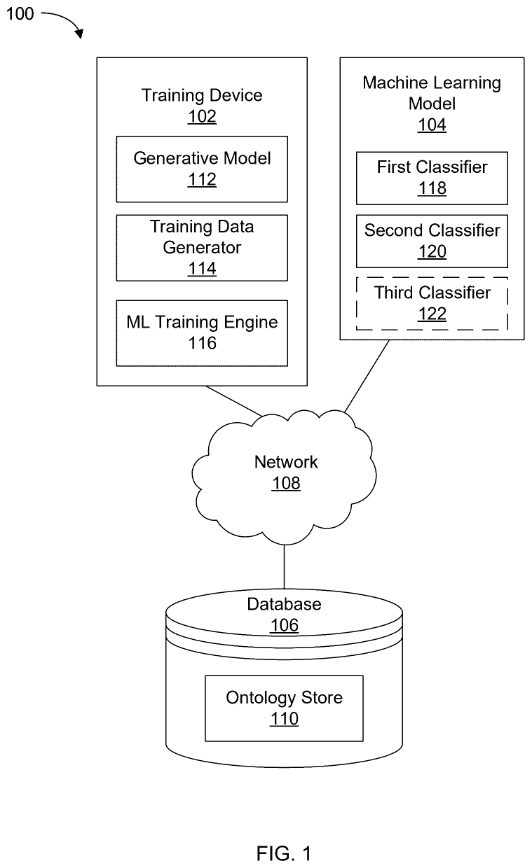

Referring now to FIG. 1, a schematic representation of an example system 100 for training a machine learning model to determine values for annotated text spans that are related to a level of confidence in the accuracy of the annotation for that text span is shown. The system 100 includes a training device 102, a machine learning engine 104, and a database 106 that may communicate with each other via a network 108. The network 108 may be any suitable wired or wireless network, or combination of wired and wireless networks including, for example, a local area network (LAN), or a wide area network (WAN), or a combination thereof.

The database 106 may include an ontology store 110 that stores an ontology related to a specific context such as, for example, the ICD-10 utilized in medical contexts. The ontology stored in the ontology store may include information that is associated with different concepts included in the ontology including, for example, concept identifiers, which may be any suitable identifier including alphanumeric codes assigned to each concept of the ontology, natural language names of the concepts, descriptions of the concepts, and/or synonyms for the concept.

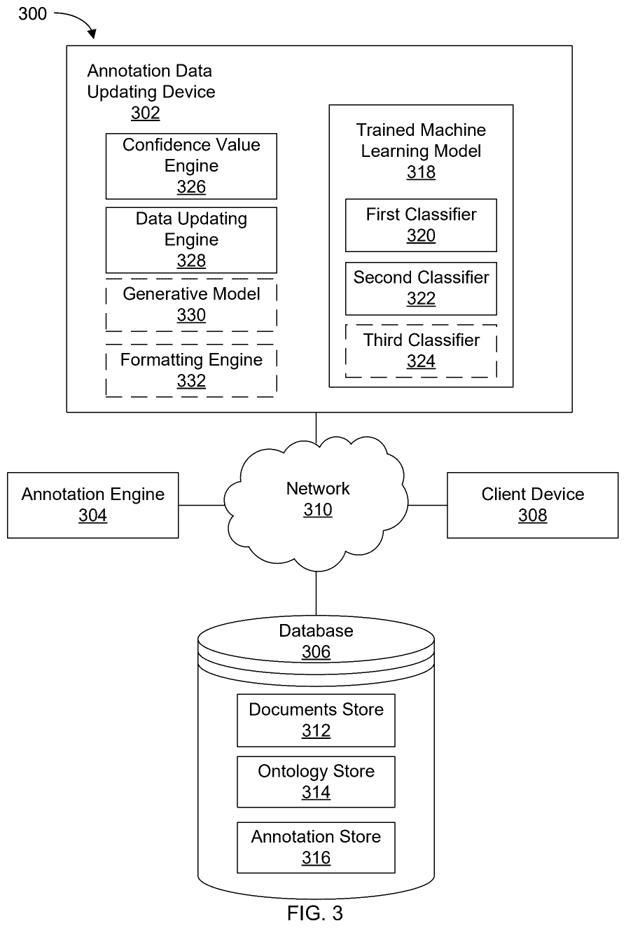

The training device 102 generates training data and utilizes the training data to train the machine learning model 104. As described in more detail below with reference to FIG. 3, the training device may generate training data for some or all of the concepts of the ontology, for example all or some of the concepts stored in the ontology store 110.

In an example embodiment, a generative model 112 of the training device 102 generates an initial sentence that includes a synonym associated with a concept of the ontology, which synonym may be included, for example, in a set of synonymous phrases stored int eh ontology store 110 in associated with the concept and which may used in place of, for example, the natural language name of that concept.

As described in more detail below, with reference to FIG. 3, a training data generator 114 of the training device 102 may create new generative sentences by replacing the original synonym with a synonym from the same concept or with a synonym associated with a different context. The new generated sentences are annotating the generated sentences as either an instance of the original concept, the different context associated with the synonym, or a concept different from the original concept and the different concept of the replacement synonym. The training data generator 114 may be configured to select different concepts and/or synonyms randomly from all other concepts and/or synonyms stored in the ontology store 110.

In an example, the training data generator 114 a corpus of annotated sentences that includes different logically possible combination of plausible and implausible states of a first label indicating remainder/description plausibility, a second label indicating synonym/concept plausibility, and a third label indicating remainder/synonym plausibility, where “remainder” refers to all parts of the sentence that are not part of the annotated synonym. The training data generator 114 may add appropriate labels to each of the generated sentences.

In some examples, for the purposes of training the machine learning model 104, a randomly sampled concept and/or synonym may be assumed to be implausible in the initial sentence, i.e., with regard to the remainder and/or the synonym of the initial sentence, although the methods disclosed herein will functions, though with potentially lower expected accuracy when this assumption is unmet.

The generated sentences with annotations that are generated by the training data generator are then stored as training data. The training data may be stored in, for example, a memory (not shown in FIG. 1) of the training device 102, in the database 106, or in some other memory device.

In some examples, the initial sentence generated by the generative model 112 is not included in the training data. This may inhibit the machine learning model 104 from attending to spurious grammatical signals in later steps of the proposed method. Because phrases in the initial sentence are replaced with other phrases when deriving the training data, there will likely be cases where the generated sentence is subtly ungrammatical or awkward because a poorly-worded phrase was sampled. Because it may be desirable for the trained machine learning model 104 to focus on the plausibility of the context-specific information when determining its input, and not on grammar. However, if the training data includes the initial sentence in the training data, this initial sentence may provide a clear grammatical signal which the machine learning model 104 may use to identify plausible remainder/synonym pairings. By omitting the initial sentence from the training data may reduce this grammatical signal and cause the machine learning model 104 to learn from primarily semantic information.

This process may be repeated for each of the concepts included in the ontology store 110, or until a predetermined amount of training data is generated. Generating training data associated with each concept of the ontology stored in the ontology store 110 may be desirable to provide training data with broad coverage for all concepts of the ontology. Further, by generating training data based on one initial sentence per concept may inhibit concepts that appear more frequently in real text of documents within the particular context of the ontology being over-represented in the training data, and that concepts that are uncommon in real text of documents within the particular context of the ontology being under-represented. For example, training data that is generated utilizing sentences extracted from pre-existing text corpora may be limited by over-representing concepts which are frequent in those corpora and under-represented for concepts which are unattested in those corpora.

The machine learning (ML) training engine 116 is configured to train the machine learning engine 104 utilizing the training data generated by the training data generator 114. In the example shown in FIG. 1, the machine learning engine 104 includes a first classifier 118 that is trained to determine whether the first label indicating remainder/concept plausibility is plausible or implausible for an input annotated text span and a second classifier 120 that is trained to determine whether the second label indicating synonym/concept plausibility is plausible or implausible for an input annotated text span. The machine learning engine 104 may optionally include a third classifier 122 that is trained to determine whether the third label indicating remainder/synonym plausibility is plausible or implausible for an input annotated text span.

In the present disclosure, “classifier” may refer to any model whose output includes a probability distribution over two classes which can be interpreted as true or false labels, or in the present disclosure “plausible” and “implausible”. Classifiers may optionally produce additional outputs. Classifiers may be models where a threshold is applied to convert scalar class likelihoods (e.g. on a scale from 0 to 1) into binary class assignments (e.g. rounded to precisely 0 or 1). All components of the machine learning model 104, e.g., the first classifier 118, the second classifier 120, and the optional third classifier 122 if included, as well as any embedded models, are, in some embodiments, part of the same underlying model or neural network and are trained jointly.

As described in more detail below, although some embodiment of determining the confidence value for an annotated text span do not utilize the output of the optional third classifier 122, and therefore the third classifier 122 may not be necessary, including the third classifier 122 in the machine learning model 104 and training the third classifier 122 together with the first classifier 118 and the second classifier 120 may result in improved performance of the first classifier 118 and second classifier 120 by causing the machine learning model to consider the synonym/concept plausibility in addition to the remainder/synonym plausibility and the remainder/concept plausibility. Including the third classifier 122 may result in, or increase the propensity for, the machine learning model 104 performing multi-task learning compared to machine learning models 104 that include only the first and second classifiers 118, 120. As described previously, multi-task learning is a type of inductive transfer that may facilitate a machine learning model 104 learning from complementary training signals when learning to perform multiple distinct but related tasks, and which may improve performance by machine learning model 104 when those multiple distinct tasks are sufficiently related.

In the present disclosure, training the machine learning model 104 may be performed by any suitable process. In general, training typically includes attempting to minimize the actual or expected error rate of the output of the first classifier 118, the second classifier 120, and the optional third classifier 122, if included, utilizing the training data for which the correct labels are included. In some embodiments of the present disclosure, the training process may include deriving weight and/or bias parameters for a neural network by means of stochastic gradient descent. Training may include testing the machine learning model 104 once it has been trained to test the accuracy of the output generated by the machine learning model 104. For example, the previously described training data that is generated by the training data generator 114 may be split into training data that is used to train the machine learning model 104, and testing data that is utilized to test the machine learning model 104 after training to determine whether the labels determined by the machine learning model match or agree with the labels that are included for the training data.

In some examples, some or all of the components shown in FIG. 1 as being part of the same physical device may be included in multiple separate physical devices that communicate via the network 108. For example, the generative model 112 may be provided in physical device that is separate from the training device 102. In other examples, devices that are shown in FIG. 1 to be separate devices may be combined in a single physical device.

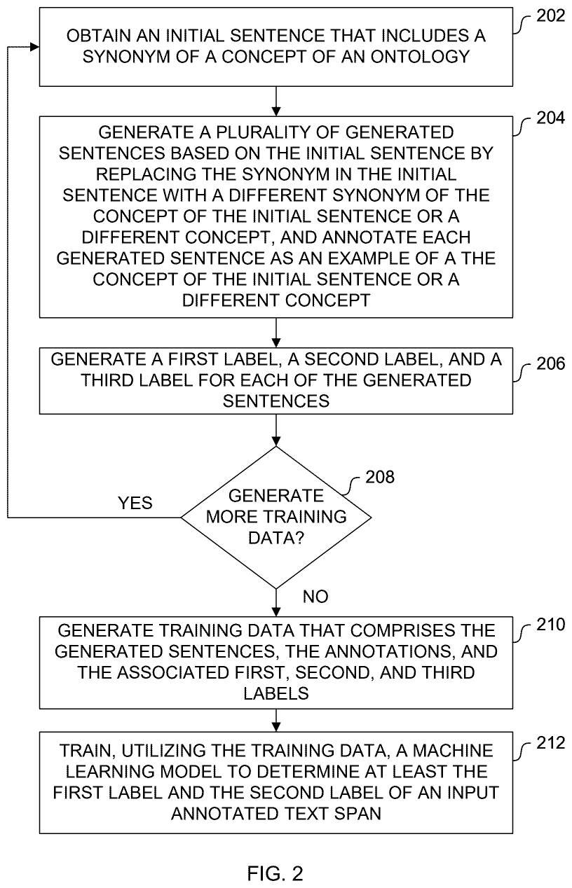

Referring now to FIG. 2, a flow chart showing an example method or process for training a machine learning model is shown. The example method or process may be performed by a training device such as, for example, the training device 102 described previously with reference to FIG. 1. The method or process may be performed by one or more processors of the training device that execute computer-readable code stored in a non-transitory memory of the coding assistant device, the computer-readable code providing instructions to the one or more processor for performing the method or process.

At 202, an initial sentence that includes a synonym associated with a concept of an ontology is obtained. Obtaining the initial sentence may include selecting a concept from an ontology such as, for example, an ontology stored in an ontology store of a database, and obtaining a synonym associated with the concept.

As described previously, the synonym may be obtained from synonyms stored in association with the concept in the ontology store, or may be generated, or may be obtained utilizing a generative model, such as the example generative model 112 described previously with reference to FIG. 1, based on the concept such as a natural language name of the concept or description of the concept stored in the ontology store. The synonym may be, for example, randomly selecting from a set of synonyms associated with the concept. Obtaining the initial sentence may be performed by utilizing a generative model to generate a sentence that includes the obtained synonym.

At 204, a plurality of generated sentences are generated based on the initial sentence by replacing the synonym in the initial sentence with a different synonym of a different synonym of the same concept of the initial sentence or a synonym of a different concept, and annotate each of the generated sentence as an example of the concept of the initial sentence or a concept different than the concept of the initial sentence, which different concept may be a different concept than the replacement synonym.

In an example embodiment, generating the generated sentences includes generating:
a first generated sentence by replacing the synonym in the initial sentence with a different synonym associated with the concept of the initial sentence, and annotating the first generated sentence as an instance of the concept of the initial sentence,
a second generated sentence by replacing the synonym in the initial sentence with a different synonym associated with the concept of the initial sentence and annotating the second generated sentence as an instance of a concept different than the concept of the initial sentence,
a third generated sentence by replacing the synonym with a synonym associated with a different concept that is different than the concept of the initial sentence and annotating the third annotated sentence as an instance of the concept of the initial sentence;
a fourth generated sentence by replacing the synonym in the initial sentence with a synonym associated with a different concept that is different the concept of the initial sentence and annotating the fourth generated sentence as an instance of that different concept associated with the replacement synonym, and
a fifth generated sentence by replacing the synonym in the initial sentence with a different synonym associated with the concept of the initial sentence and annotating the fifth generated sentence as an instance of a concept that is different than the concept of the initial sentence.

The different synonyms and/or concepts that are utilized when generating the generated sentences at 204 may be randomly selected from all other synonyms and/or concepts stored in the ontology store.

At 206, a first label, a second label, and a third label are generated for each of the generated sentences generated at 204. In an example, the first label indicates remainder/concept plausibility, the second label indicates synonym/concept plausibility, and a third label indicates remainder/synonym plausibility, where “remainder” refers to all parts of the sentence that are not part of the annotated synonym. The training data generator 114 may add appropriate labels to each of the generated sentences.

Continuing the previous example of the first through fifth generated sentences set out previously, generating the labels at 206 includes generating the first, second, and third labels as follows:
for the first generated sentence, the first, second, and third labels indicate plausible,
for the second generated sentence, the third label indicates plausible, and the first and second labels indicate implausible,
for the third generated sentence, the first label indicates plausible, and the second and third labels indicate implausible,
for the fourth generated sentence, the second label indicates plausible and the first and third labels indicate implausible, and
for the fifth generated sentence, the first, second, and third labels indicate implausible.

At 208, a determination whether to generate more training data is made. For example, training data may be generated by obtaining an initial sentence as described at 202 for each concept included in the ontology, then generating training data as described at 204 and 206 for each initial sentence. In this case, the determination at 208 may be whether or not the process described at 202 to 206 has been performed for each concept in the ontology. In other examples, the process may be performed for a predetermined number of concepts, or until a predetermined amount of training data is generated, and in these case the determination at 208 may be a determination that the predetermined number of concepts have been utilized to generate training data, or that the predetermined amount of training data has been generated.

As described previously, generating training data based on all of the concepts of the ontology may be desired because this may inhibit over-representation in the training data of concepts that are frequently found in text of documents related to the specific context and under-representation in the training data of concepts that are not commonly used in text of documents related to the specific context.

If the determination at 208 is “NO”, the process returns where a new initial sentence is obtained for a new concept of the ontology. Thus, this process described with reference to 202, 204, and 206 is repeated for different concepts until the determination at 208 is “YES”.

If the determination at 208 is “YES”, then the process proceeds to 210 where training data that comprises the generated sentences, the annotations of the generated sentences, and the first, second, and third labels for the generated sentences. Each generated sentence, its associated annotation, and its associated first, second, and third labels may form a training data element, and all of the training data elements that are generated based on the initial sentences for the different concepts in the ontology collectively form the training data generated at 208. Generating the training data may include storing the training data in a memory of the training device or another memory, such as in a database.

As described previously, in some embodiments the initial sentence is not included in the training data that is generated at 210 to inhibit the machine learning model learning to determine the first, second, and third labels based on grammatical signals and attempt to promote the machine learning model to learn to determine the first, second, and third labels based on semantic information.

In some examples, generating the training data may include including, for some or all of the generated sentences, a description associated with the concept that that generated sentence is annotated to be an example of is included in the training data. The description may be any representation of the concept including, for example, a definition from a textbook of the context relevant to the ontology, a textbook-style definition obtained by querying an LLM or other generative model, an identifier or code utilized to identify the concept in the ontology, such as, for example, a SNOMED-CT Identifier (SCTID) or similar code from a medical ontology, or a natural-language name for the concept such as, in the case in which the ontology is the Systematized Nomenclature of Medicine-Clinical Terms (SNOMED-CT) the natural language name may be fully-specified name (FSN) set out in the SNOMED-CT.

In some examples the training data, or portion of the training data may be generated in a particular format. In an example, the generated sentence may be formatted to separate the synonym and the remainder of the generated sentence and the description of the concept that the synonym is annotated with. In one example, the following template may be utilized:
<remainder_left>[MASK]<remainder_right>[September]<synonym>[September]<description>
where [September] is a delimiter, which may be similar to, for example, the separator token from a BERT-style transformer model but which in the general method could be any delimiter chosen by the user to demarcate the different sections of the input. <remainder_left> and <remainder_right> stand for the text of the sentence to the left and right, respectively, of the annotated synonym. [MASK] may be a token used to mark the original position of the annotated synonym, in order to create a representation of the remainder without the synonym. <synonym> stands for the text of the annotated synonym. <description> stands the description of the concept that synonym is annotated with in the generated sentence, as described previously.

In some embodiments, a dense vector representation for the templated generated sentence may be generated and stored as training data. The dense vector representation may be generated using any suitable text embedding model that converts a sequence of text tokens into a fixed-sized vector of real numbers. A possible embodiment of this process may be to mean-pool the token representations from a Transformer encoder.

In a “cross-encoding” embodiment, the each templated generated sentence is encoded as a single dense vector representation.

In a “tri-encoding” embodiment, the remainder, the synonym, and the description of each generated sentence are each encoded as a separate dense vector representation such that a first vector representation is generated for the remainder, a second vector representation is generated for the synonym, and a third vector representation is generated for the description. As described in more detail below, tri-encoding enables providing each classifier of the machine learning model with only the portions of the training data that are relevant to the label that it is trained to determine.

The primary difference between the tri-encoding approach and the cross-encoding approach is that each of the cross-encoder classifiers receive the complete input comprising a remainder, annotated portion of text span, and description. By contrast, each of the tri-encoder classifiers only receive the particular parts of the input that are relevant to their prediction. In other words, each classifier in the tri-encoding approach as described previously will have access to only two of the three vector representations for a given input.

A potential advantage of tri-encoding is that, because each part of the generated sentence is encoded separately, these parts can be cached, and whenever a repeated remainder, synonym, or description is encountered, its vector representation can be fetched from the cache rather than regenerated again, reducing the processing resources and memory required for generating the training data. Further, because each classifier is only evaluating the portions of input that are relevant to its prediction, tri-encoder classifiers may, in some situations, output predictions more quickly than cross-encoder classifiers, potentially increasing processing efficiency and reducing processing resources utilized.

Because the classifiers in a tri-encoding embodiment receive less information than in a cross-encoding embodiment, the classifiers may be less performant in the sense that, for example, the classifiers in a tri-encoding embodiment may replicate the labels from the training data with reduced accuracy as cross-encoding embodiments, or in the sense that the scores outputs by classifiers in a tri-encoding embodiment may be less interpretable to human experts compared to cross-encoding embodiments. In an illustrative example of this, a synonym may be a word that is ambiguous or that the embedding model of the machine learning model has not encountered previously during training. In such cases, classifiers in a cross-encoding embodiment may be able to utilize the other information that is extraneous to its particular determination, such as the concept description, to disambiguate or otherwise understand the synonym. Without this added context, the representations produced by classifiers in a tri-encoding embodiment may lack nuance, resulting in these classifiers being less effective, in certain situations, in performing their task compared to a classifier in a cross-encoding embodiment. However, advantageously, classifiers in a tri-encoding embodiment may run more quickly than classifiers in cross-encoding embodiment because there is less information to process, increasing the overall processing efficiency of the machine learning model.

At 212, a machine learning model is trained utilizing the training data to determine at least the first label and the second label of an input annotated text span. The machine learning model may be similar to, for example, the example machine learning model 102 described previously such that the first classifier 118 is trained to determine the first label of an input annotated text span and a second classifier 120 is trained to determine the second label of an input annotated text span. In examples in which the machine learning model includes the optional third classifier, such as the example optional third classifier 122 of the machine learning model 104 described previously, training the machine learning model includes training the third classifier to determine the third label of an input annotated text span. As described previously, training an optional third classifier to determine the third label result in more accurate determinations of the first and second labels by the first and second classifiers, respectively.

As described previously, training the machine learning model may be performed by any suitable process that attempts to minimize the actual or expected error rate of the output of the first classifier, the second classifier, and the optional third classifier, if included, utilizing the training data for which the correct labels are included. The training performed at 212 may include deriving weight and/or bias parameters for a neural network by means of stochastic gradient descent. Training may include testing the machine learning model once it has been trained to test the accuracy of the output generated by the machine learning model. For example, the previously described training data that is generated at 210 may be split into training data that is used to train the machine learning model, and testing data that is utilized to test the machine learning model after training to determine whether the labels determined by the machine learning model match or agree with the labels that are included for the training data.

As noted previously, in tri-encoder embodiments in which the remainder, the synonym, and the description of each generated sentence are each encoded as a separate dense vector representation, training may be performed by providing each classifier with only the vector representations relevant to the label it is being trained to determine. For example, the first classifier that is trained to determine a first label associated with a remainder/context plausibility may be trained utilizing only the first vector representation of the remainder and the third vector representation of the description, but not the second vector representation of the synonym. Similarly, the second classifier that is trained to determine the second label associated with the synonym/concept plausibility may be trained utilizing only the second vector representation of the synonym and the third vector representation of the description, but not the first vector representation of the remainder. Similarly, if the optional third classifier is included and is trained to determine the third label associated with the remainder/synonym plausibility, the third classifier may be trained utilizing only the first vector representation of the remainder and the second vector representation of the synonym, but not the third vector representation of the description.

In an example embodiment, the machine learning model is trained such that the first classifier is trained to generate a first value that indicates whether the first label of an annotated text span is plausible or implausible, and the second classifier is trained to generate a third value that indicates whether the second label of the annotated text span is plausible or implausible, and, if included in the machine learning engine, the third classifier is trained to generate a third value that indicates whether the third label of the annotated text span is plausible or implausible. The first value, the second value, and, if the third classifier is included in the machine learning model, the third value may be a value between 0 and 1, where values closer to 1 indicate a greater likelihood that the label is plausible and a value closer to 0 indicates a greater likelihood that the label is implausible.

In some examples, the first classifier may be trained to also generate a first accuracy value, the second classifier may be trained to also generate a second accuracy value, and if included, the third classifier may be trained to also generate a third accuracy value. The first, second, and third accuracy values may be a value that indicates the expected or predicted accuracy of the first, second, and third values respectively. For example, when the first accuracy score is close to 1, this may be interpreted as meaning that the first classifier has determined that the first value is trustworthy, whereas when the first accuracy score is close to 0, this may be interpreted as meaning that the first classifier has determined that the first value may be spurious, perhaps because the first classifier has not seen an input of this type during training.

In a second aspect of the present disclosure, once the classifiers of the machine learning model have been trained as described previously, the trained machine learning model may be utilized to evaluate the contextual suitability and/or plausibility of concept identifiers that are linked to spans of text in, what is referred to herein, as annotated text spans. To utilize the machine learning model, annotation data that includes annotated text spans are obtained. The annotation text spans may be formatted in some examples, based on how the classifiers of the machine learning model are configured and trained. For example, if the classifiers are configured and trained as cross-encoders or tri-encoders, then the annotated text spans may be appropriately formatted to obtain vector representations of the annotated text spans as described previously. The annotation data is input into the machine learning model to obtain values from each of the classifiers. Once obtained, the values from the classifiers may be utilized to determine a confidence value, and the annotation data may be updated based on the confidence value by, for example, appending each confidence value to its associated annotated text span and/or filtering the annotation data to remove annotation text spans that having confidence values that are, for example, less or equal to a threshold value, or that are, for example, greater than or equal to a threshold value.

Filtering the annotated data may reduce the number of annotation text spans included in the annotated data, which may improve the speed and efficiency of subsequent analysis that is performed utilizing the annotated data, as well as required memory resources required to store the annotated data.

Further, the annotation data may be filtered to obtain annotation data that is related to a particular interest. For example, annotation text spans for which the associated annotated text-concept related value is above 0.5 may be removed from the annotation data such that the remaining annotation text spans are instances that are more likely to have been labeled incorrectly, which may be utilized to identify and correct errors in the process by which the annotation data was originally produced, resulting in an improved overall computer system for generating annotation data.

Alternatively, in another example, the annotated text spans having confidence values below a threshold, for example, for which the average of the three scores from the three classifiers is less than 0.5, may be removed. In this example, the annotated text spans remaining in the annotation data may be more likely to have been annotated correctly, and therefore comprise a cleaner set of data to analyze relative to the unfiltered set of annotation data. Subsequent analysis utilizing the filtered annotation data, including analysis by LLMs performed using the documents from which the annotation data was generated, may be more reliable and less prone to errors, or “hallucinations”, by removing the annotation data that is the least reliable, resulting an improved overall computer system for analyzing documents.

Even in examples in which the annotation data is updated to include the confidence values, but not filtered as described above, such confidence values may be utilized during subsequent analysis that utilizes the annotation data to improve the result of the subsequent analysis. For example, LLMs that performed analysis or processing of the documents from which the annotation data was generated, may utilizes to confidence values in the annotated data to determine a reliability of each annotated text span and may, for example weigh annotated text spans, or rely less on annotated text spans, having lower confidence values, or may discard annotated text spans having confidence values lower than a threshold value, which may result in the output of the LLM being more reliable and less prone to errors or hallucinations, resulting an improved overall computer system for analyzing documents.

Referring now to FIG. 3, a schematic representation of an example system 300 for determining confidence values for annotated text spans and updating annotation data based on the determined confidence values associated with annotated text spans of the annotated data is shown. The confidence values are related to a level of confidence in the accuracy of the annotation for that text span. The system 300 includes a confidence value determining device 302, an annotation engine 304, a database 306, and a client device 308 that may communicate with each other via a network 310. The network 308 may be any suitable wired or wireless network, or combination of wired and wireless networks including, for example, a local area network (LAN), or a wide area network (WAN), or a combination thereof.

The database 310 may include a document store 312 that stores electronic documents, an ontology store 314 that stores an ontology related to a specific context such as, for example, the ICD-10 utilized in medical contexts, and an annotation store 316. The document store 312 may be, for example, part of an electronic record keeping system, or any other suitable document management system, that stores records for a particular context such as, for example, medical context, legal context, financial context, business context, and the like. The annotation store 316 may store annotation data that may be generated by the annotation engine utilizing, for example, documents stored in the document store 312. Similar to the ontology store 110 of the database 106 described previously with reference to FIG. 1, the ontology stored in the ontology store 314 may include information that is associated with different concepts included in the ontology including, for example, concept identifiers, which may be any suitable identifier including alphanumeric codes assigned to each concept of the ontology, natural language names of the concepts, descriptions of the concepts, and/or synonyms for the concept.

The annotation engine 304 is configured to process one or more documents, for example documents stored in the document store 312, and link spans of text in the document to concepts included in an ontology, such as for example, concepts included in the ontology store 314 to generate annotation data. The annotation engine 304 be, for example, a rule-based string matching system, neural network entity-linking model, an LLM such as, for example, a fine-tuned LLM that is trained specially for a specific context. The annotation data is generated by the annotation engine 304 by identifying a span of text in the document, such as a sentence, and linking a term or phrase in that span of text to a concept included in the ontology, such as the ontology stored in the ontology store 314.

The annotated data may then include the span of text, an indication indicating the term or phrase that is annotated, and a description of the concept from the ontology that the term or phrase is linked to. The description included in the annotation data may be any representation of the concept including, for example, a definition from a textbook of the context relevant to the ontology, a textbook-style definition obtained by querying an LLM or other generative model, an identifier or code utilized to identify the concept in the ontology, such as, for example, a SNOMED-CT Identifier (SCTID) or similar code from a medical ontology, or a natural-language name for the concept such as, in the case in which the ontology is the Systematized Nomenclature of Medicine-Clinical Terms (SNOMED-CT) the natural language name may be fully-specified name (FSN) set out in the SNOMED-CT.

In the present disclosure, “annotated text span” refers to a single annotated span of text that may be included in the annotated data, that may include the annotated phrase, the remainder of the text span other than the annotated phrase, and the description.

The annotation data updating device 302 includes a trained machine learning model 318 includes a first classifier 320 that is trained to determine whether a first label indicating remainder/description plausibility is plausible or implausible for an input annotated text span and a second classifier 322 that is trained to determine whether a second label indicating annotated text/concept plausibility is plausible or implausible for the input annotated text span. The trained machine learning engine 318 may optionally include a third classifier 324 that is trained to determine whether the third label indicating remainder/annotated text plausibility is plausible or implausible for the input annotated text span.

It is noted that in the previous section, the training data generated sentences included “synonyms” related to a concept that were linked to the concept. However, annotation data that is utilized during deployment of the trained machine learning model does not included “synonyms”, but rather annotated text. Therefore, whereas the description of the labels applied during training referred to “synonyms”, during deployment of the trained machine learning model, such references to “synonyms” are replaced with “annotated text” when describing the data input to the machine learning model and when describing the labels that are determined by the machine learning model.

The trained machine learning model 318 may be the machine learning model that results after being trained, for example, according to the process described previously with reference to FIG. 2.

As described in more detail below, although some embodiments of determining the confidence value for an annotated text span do not utilize the output of the optional third classifier 324, and therefore the third classifier 324 may not be necessary to determine the confidence value, including the third classifier 324 in the machine learning model 318 and utilizing the third classifier 324 together with the first classifier 320 and the second classifier 322 may result in improved performance of the first classifier 320 and second classifier 322 by causing the machine learning model 318 to consider the synonym/concept plausibility in addition to the remainder/synonym plausibility and the remainder/concept plausibility. This may result benefit determinations by the first and second classifiers 320, 322 by, for example, causing the machine learning model 318 to utilize multi-task learning which, as described previously, may facilitate, or increase, inter-task information transfer between the classifiers 320, 322, 324, which may improve the overall accuracy of the trained machine learning model 318.

In an example embodiment, the trained machine learning model 318 is trained such that the first classifier 320 is trained to generate a first value that indicates whether the first label of an annotated text span is plausible or implausible, and the second classifier is trained to generate a third value that indicates whether the second label of the annotated text span is plausible or implausible, and, if included in the machine learning engine, the third classifier is trained to generate a third value that indicates whether the third label of the annotated text span is plausible or implausible. The first value, the second value, and, if the third classifier is included in the machine learning model, the third value may be a value between 0 and 1, where values closer to 1 indicate a greater likelihood that the label is plausible and a value closer to 0 indicates a greater likelihood that the label is implausible.

In some examples, the first classifier may be trained to also generate a first accuracy value, the second classifier may be trained to also generate a second accuracy value, and if included, the third classifier may be trained to also generate a third accuracy value. The first, second, and third accuracy values may be a value that indicates the expected or predicted accuracy of the first, second, and third values respectively. For example, when the first accuracy score is close to 1, this may be interpreted as meaning that the first classifier has determined that the first value is trustworthy, whereas when the first accuracy score is close to 0, this may be interpreted as meaning that the first classifier has determined that the first value may be spurious, perhaps because the first classifier has not seen an input of this type during training.

The annotation data updating device 302 also includes a confidence value engine 326 that receives the output from the trained machine learning model 318 for an input annotated text span and generates a confidence value for the annotated text span. The data updating engine 328 updates the annotated data to include the confidence value that is determined by the confidence value engine 326. Updating the annotation data may include, for example, updating each annotated text span stored in, for example, the annotation store 316, to include the confidence value determined for that annotated text span. Alternatively or additionally, updating the annotation data by the data updating engine 328 may also include determining annotated text spans having a confidence value that is less than or equal to a threshold value, and flagging those annotated text spans or deleting or otherwise removing those annotated text spans from the annotated data.

The annotation data updating device 302 may optionally include a generative model 330 that may be utilized to generate, for example, descriptions associated with the concepts for the annotated text spans. For example, the generative model may be utilized to generate a definition or a description of the annotated text in the text span, or the description when the description is, for example, a concept identifier or a natural language name associated with the concept. In these cases, the description that is included in the annotated text span may be replaced with the definition or description generated by the generative model prior to being input into the trained machine learning engine 318 to provide additional information that the trained machine learning model 318 may utilize to determine the labels for the annotated text span. This additional information may include information that, for example, disambiguates ambiguous terms in, for example, the concept name, and/or that explicitly describes the contexts in which the concept is or is not expected to occur, and/or that describes a concept that the machine learning model was not exposed to during training and that the machine learning model may, therefore, be unrecognized on the basis of a concept identifier alone.

The annotation data updating device 302 may optionally include a formatting engine 332 that, for example, formats the annotation data according to template, and/or generates one or more vector representations of the annotation text spans prior to inputting into the trained machine leaning model 318 in cross-encoding or tri-encoding embodiments, as describe previously.

The client device 308 may be utilized to cause the annotation engine 304 to generate annotation data for one or more documents. For example, the client device may issue commands to the annotation engine 304 to generate annotation data, and the command may be included with the one or more documents for which annotation data is to be generated, or may include pointers to a storage location of the one or more documents in, for example, the document store 306 of the database 306 such that the annotation engine 304 may obtain the one or more documents.

The client device 308 may also communicate with the annotation data updating device 302 to cause the annotation data updating device 302 to update annotation data generated, for example, by the annotation engine 304 and/or stored, for example, in the annotation store 316. For example, the client device 308 may issue commands to the annotation data updating device 302 to update the annotation data, and the command may include the annotation data to be updated, or may include pointers to a storage location of the annotation data in, for example, the annotation store 316 of the database 306 such that the annotation data updating device 302 may obtain the annotation data. In an example, the client device 308 may issue a command to the annotation data updating device 302 to generate annotation data for one or more documents, and the annotation data updating device 302 may then be configured to issue a command to the annotation engine 304 to generate the annotation data for the one or more documents, then update the annotation data that is generated by the annotation engine 304, then provide the updated annotation data to the client device 308.

In other examples, an input device of the annotation data updating device may be utilized, rather than a client device 308, to initiate updating of annotation data, or the annotation data may be automatically updated whenever annotation data is generated by the annotation engine 304, or new annotation data is stored to the annotation store 316.

In some examples, some or all of the components shown in FIG. 3 as being part of the same physical device may be included in multiple separate physical devices that communicate via the network 310. For example, the generative model 330 and/or the trained machine learning model 318 may be provided in physical devices that are separate from the annotation data updating device 302. In other examples, devices that are shown in FIG. 3 to be separate devices may be combined in a single physical device.

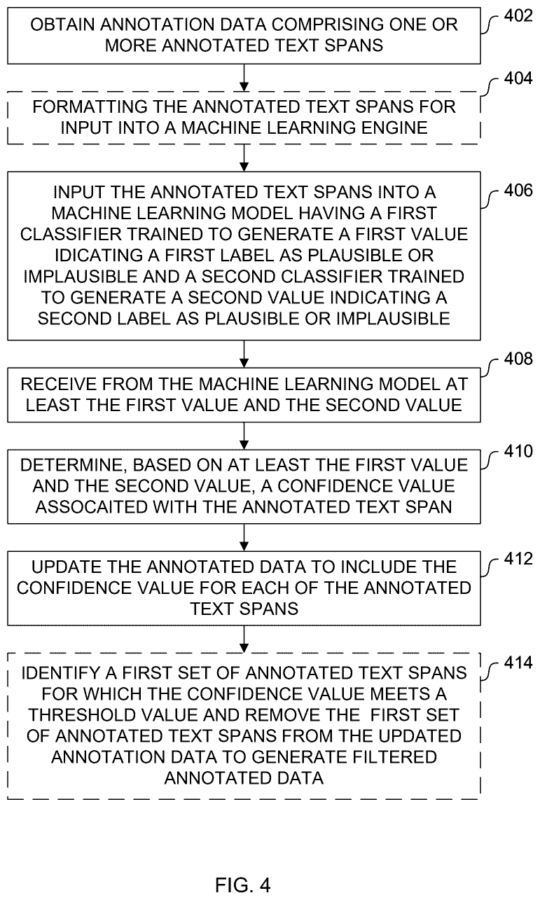

Referring now to FIG. 4, a flow chart showing an example method or process for updating annotation data is shown. The example method or process may be performed by a coding assistant device such as, for example, the coding assistant device 106 described previously with reference to FIG. 1. The method or process may be performed by one or more processors of the coding assistant device that execute computer-readable code stored in a non-transitory memory of the coding assistant device, the computer-readable code providing instructions to the one or more processor for performing the method or process.

At 402, annotation data comprising one or more annotation text spans are obtained. The annotation data may be generated by any suitable process and may be generated by an annotation engine such as the example annotation engine 304 described previously. An annotation text span may include annotated text, which is text of the text span that is linked in some way to a concept, a remainder, which is the text of the text span other than the annotated text, and a description, which description may be any information that identifies and/or describes the concept that the annotated text is linked to and may include, for example, any representation of the concept including, for example, a definition from a textbook of the context relevant to the ontology, a textbook-style definition obtained by querying an LLM or other generative model, an identifier or code utilized to identify the concept in the ontology, such as, for example, a SCTID or similar code from a medical ontology, or a natural-language name for the concept such as, in the case in which the ontology is the SNOMED-CT the natural language name may be the FSN set out in the SNOMED-CT.

In some examples, obtaining the annotated data may include generating a description and/or a description of the concept of each annotated text span, which is then included in the annotated text span. For example, the description may be a textbook-style definition, or some other description of the concept, that may be obtained by, for example, querying an LLM or other generative model, such as the example generative model 330 described previously.

At 404, the annotated text spans may optionally be reformatted for input into a trained machine learning engine. For example, similar to the formatting that may be performed when generating the training data as previously described with reference to 210 of FIG. 2, in some examples the annotated text spans may be formatted to separate the annotated text, the remainder, and the description. In one example, the following template may be utilized:
<remainder_left>[MASK]<remainder_right>[September]<annotated text>[September]<description>
where [September] is a delimiter, which may be similar to, for example, the separator token from a BERT-style transformer model but which in the general method could be any delimiter chosen by the user to demarcate the different sections of the input. <remainder_left> and <remainder_right> stand for the text of the sentence to the left and right, respectively, of the annotated text. [MASK] may be a token used to mark the original position of the annotated text, in order to create a representation of the remainder without the annotated text. <annotated text> stands for the annotated text and <description> stands the description of the concept that annotated text is linked to via the annotation.

In some embodiments, a dense vector representation for the templated annotation span. The dense vector representation may be generated using any suitable text embedding model that converts a sequence of text tokens into a fixed-sized vector of real numbers. A possible embodiment of this process may be to mean-pool the token representations from a Transformer encoder.

In a “cross-encoding” embodiment, each templated annotated text span is encoded as a single dense vector representation. In a “tri-encoding” embodiment, the remainder, the annotated text, and the description of each annotated text span are each encoded as a separate dense vector representation such that a first vector representation is generated for the remainder, a second vector representation is generated for the annotated text span, and a third vector representation is generated for the description.

At 406, each of the annotated text spans are input into a machine learning model comprising at least a first classifier trained to generate a first value that indicates a first label of the text span a plausible or implausible, the first label associated with plausibility between the remainder and the description of the annotated text span, and a second classifier trained to generate a second value that indicates a likelihood of a second label of the text span being plausible, the second label associated with a plausibility between the annotated text and the description.

As described previously, in some embodiments, the machine learning engine may also include a third classifier trained to generate a third value that indicates a likelihood of a third label of the text span being plausible, the third label associated with a plausibility between the remainder and the annotated text. The third classifier may also be trained to generate a third accuracy value indicating an expected accuracy of the third value.

In cross-encoder embodiments in which the annotation text spans are formatted in accordance with a template, then a vector representation of the templated annotated text span is generated, inputting the annotation text span at 406 comprises inputting the vector representation.

In tri-encoder embodiments in which the remainder, the annotated text, and the description are encoded respectively as three separate vector representations, namely a first vector representation of the remainder of the text span, a second vector representation of the annotated text, and a third vector representation of the description, inputting the annotated text spans at 406 may include inputting the first, second, and third vector representations.

In an example, the first, second, and third vector representations may be separately input directly into each of the first classifier, the second classifier, and, if included, the third classifier. In this example, only the first and third vector representations are input into the first classifier, only the second and third vector representations are input into the second classifier, and, if the third classifier is included, only the first and second vector representations are input into the third classifier.

In other tri-encoder examples, all three vector representations are input to the machine learning model, and the machine learning model is configured to pass along only the relevant vector representations to each of the classifiers such that only the first and third vector representations are input into the first classifier, only the second and third vector representations are input into the second classifier, and, if the third classifier is included, only the first and second vector representations are input into the third classifier.

At 408, at least the first value and the second value are received from the machine learning model for each of the annotated text spans. In examples in which the third classifier is included in the machine learning model, the third value may additionally be received at 408.

As described previously, the first value, the second value, and, if the third classifier is included in the machine learning model, the third value received at 408 may be a value between 0 and 1, where values closer to 1 indicate a greater likelihood that the label is plausible and a value closer to 0 indicates a greater likelihood that the label is implausible.

In some examples, the first classifier may be trained to also generate a first accuracy value, the second classifier may be trained to also generate a second accuracy value, and if included, the third classifier may be trained to also generate a third accuracy value, and in such examples, the first and second accuracy values, and, if the third classifier is included in the machine learning model, the third accuracy value, may also be received at 408. As described previously, the first, second, and third accuracy values may be a value that indicates the expected or predicted accuracy of the first, second, and third values respectively. For example, when the first accuracy score is close to 1, this may be interpreted as meaning that the first classifier has determined that the first value is trustworthy, whereas when the first accuracy score is close to 0, this may be interpreted as meaning that the first classifier has determined that the first value may be spurious, perhaps because the first classifier has not seen an input of this type during training.

At 410, a confidence value associated with the annotated text span is determined based on, at least, the first and second values received at 408. In some examples, the confidence value may simply be some or all of the values received from the machine learning engine at 408, which may include some or all of the first, second, and third values and the first, second, and third accuracy values. In other embodiments, the confidence value may be some other value/values that is/are derived from some or all of the values received from the machine learning model at 408.

In one example, the confidence value determined at 410 may be a confidence-weighted product of probabilities that is determined utilizing the first value, the second value, the first accuracy value, and the second accuracy value. In this example, these values may be combined as follows:

$$confidence value = A \times C \times E$$

where A is the first value, C is the second value, and E is the smaller of the first and second accuracy values. The confidence value determined in this example may be interpreted as a likelihood that the remainder-concept pairing is plausible and that the annotated text-concept is also plausible, weighted by the first and second classifiers' confidence in their own determinations. Because E equals the lower of the first and second accuracy values, the weighting that is provide by E is pessimistic, where any uncertainty from either of the first and second values will lead to a reduction in the overall score. A less conservative embodiment could instead use the greater of the first and second accuracy values, which would bias that the confidence value towards being more trustworthy compared to the previous more pessimistic example, such as long as either of the first or second values is considered trustworthy.

In another example, the confidence value determined at 410 may be a confidence-weighted average of probabilities determined utilizing the first value, the second value, the first accuracy value, and the second accuracy value. In this example, these values may be combined as follows:

$$confidence value = \frac{A + C}{2} \times E$$

where A is the first value, and C is the second value, and E is the smaller of the first and second accuracy values. Here the confidence value is an average of the likelihoods of the first and second values, again weighted by the confidence of the underlying classifiers indicated by first and second accuracy values. Similar to the previous example, the weighting here is pessimistic. In other examples, a less conservative approach could be implemented by using the greater of the first and second accuracy values as the weighting value, E.

In another example, the confidence value determined at 410 may be an unweighted average of probabilities determined utilizing the first value and the second value. In this example, these values may be combined as follows:

$$confidence value = \frac{A + C}{2}$$

where A is the first value and C is the second value. In some instances, the classifiers of the machine learning model may not be trained, or otherwise configured to provide accuracy values, or the accuracy values may not be meaningfully distinct from the first and second values, making their inclusion in the final formula redundant, in which case this unweighted average of probabilities may be utilized to determine the confidence value.

It is noted that the above-described examples do not utilize values generated by the optional third classifier, which compares the remainder and annotated text. There may be various reasons why an embodiment not include outputs from one or more of the classifiers of the machine learning model when determining the confidence score.

For example, the value output by that classifier may be redundant in view of the other values of the other classifiers. For example, if it is known a priori that a given annotated text has been linked with the correct concept (for example, because the label was assigned by a human expert), then the remainder/annotated text value (e.g., the third value determined by the third classifier) and remainder/concept value (e.g., the first value determined by the first classifier) should, ideally, be approximately equivalent and one of them may be ignored. Additionally, in, for example, real clinical text in a document in medical context, it may be assumed that all annotated text is plausible relative to the remainder, because the data was presumably prepared by a qualified professional, and so the remainder/annotated text value (e.g., the third value determined by the third classifier) may be ignored. By contrast, in annotated data that has been generated based on text that was retrieved from potentially unreliable sources, such as the internet, and which may include, for example, in a medical context, discussions of medical ideas by non-experts, the remainder/annotated text value (e.g., the third value determined by the third classifier) may be more relevant to the confidence value associated with such annotated data given that higher likelihood that the author has gotten their terminology confused and used the wrong phrase to refer to their condition.

Notwithstanding that not all of the values determined by all three classifiers of the machine learning model may be utilized when determining the confidence score at 410, it may be beneficial to include all three classifiers, i.e., include the optional third classifier, in the machine learning model during at least the training of the machine learning model, as this helps to maintain a clearer separation between the different sub-tasks and may inhibit the classifiers from attending too strongly to information that is orthogonal to their own intended task.

At 412, the annotated data is updated to include the confidence value for each of the annotated text spans. Updating the annotation data stored in a database, such as the example annotation store 316 of the example database 306 described previously.

The annotation data is updated to include the confidence values, but not filtered as described above, such confidence values may be utilized during subsequent analysis that utilizes the annotation data to improve the result of the subsequent analysis. For example, LLMs that performed analysis or processing of the documents from which the annotation data was generated, may utilizes to confidence values in the annotated data to determine a reliability of each annotated text span and may, for example weigh annotated text spans, or rely less on annotated text spans, having lower confidence values, or may discard annotated text spans having confidence values lower than a threshold value, which may result in the output of the LLM being more reliable and less prone to errors or hallucinations, resulting an improved overall computer system for analyzing documents.

Optionally, at 414, a first set of annotated text spans for which the confidence value meets a threshold may be identified, and the annotation data may be updated to remove the identified first set of annotated text spans from the annotation data to generate filtered annotated data. For example, annotated text spans having a confidence value that is less or equal to a threshold value, or that is, for example, greater than or equal to a threshold value may be removed from the annotated data stored in a database such as, for example, the example annotation store 316 of the example database 306 described previously.

As described previously, filtering the annotated data may reduce the number of annotation text spans included in the annotated data, which may improve the speed and efficiency of subsequent analysis that is performed utilizing the annotated data, as well as required memory resources required to store the annotated data.

Further, the annotation data may be filtered to obtain annotation data that is related to a particular interest. For example, annotation text spans for which the associated annotated text-concept related value is above 0.5 may be removed from the annotation data such that the remaining annotation text spans are instances that are more likely to have been labeled incorrectly, which may be utilized to identify and correct errors in the process by which the annotation data was originally produced, resulting in an improved overall computer system for generating annotation data.

Alternatively, in another example, the annotated text spans having confidence values below a threshold, for example, for which the average of the three scores from the three classifiers is less than 0.5, may be removed. In this example, the annotated text spans remaining in the annotation data may be more likely to have been annotated correctly, and therefore comprise a cleaner set of data to analyze relative to the unfiltered set of annotation data. Subsequent analysis utilizing the filtered annotation data, including analysis by LLMs performed using the documents from which the annotation data was generated, may be more reliable and less prone to errors, or hallucinations, by removing the annotation data that is the least reliable, resulting an improved overall computer system for analyzing documents.

The Appendix hereto includes an unpublished article entitled “Confidence Estimation using a Few-Shot Cross-Encoder to Determine Contextual Matches for Ontology Concepts” prepared by the inventors of the present disclosure includes further description related to the present disclosure, including experimental results of processes as described herein, and is incorporated into present disclosure by reference.

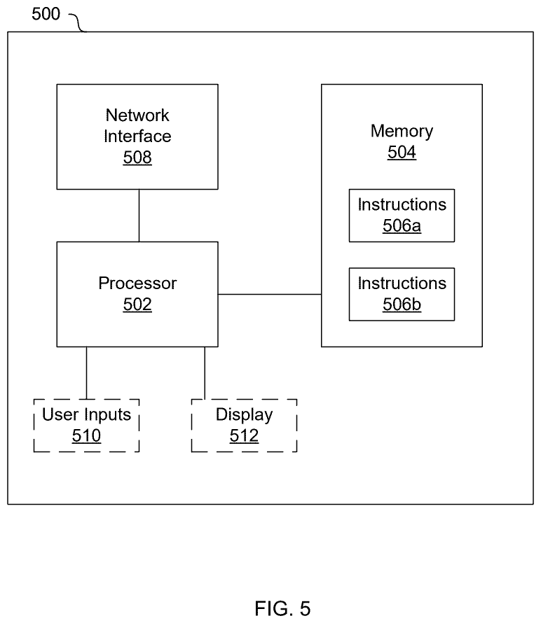

Referring to FIG. 5, a schematic diagram illustrating various physical and logical components of an exemplary apparatus 500 for a training device, such as the example training device 102, a machine learning model, such as the example machine learning models 104 and 318, and/or an annotation data updating device, such as the example annotation data updating device 302, in accordance with an embodiment is shown. Although an example embodiment of the apparatus 500 is shown and discussed below, other embodiments may be used to implement examples disclosed herein, which may include components different from those shown. Although FIG. 5 shows a single instance of each component of the apparatus 500, there may be multiple instances of each component shown.

The apparatus 500 includes one or more processors 502, such as a central processing unit (CPU), a microprocessor, an application-specific integrated circuit (ASIC), a field-programmable gate array (FPGA), a dedicated logic circuitry, a graphics processing unit (GPU), a tensor processing unit, a neural processing unit, a dedicated artificial intelligence processing unit, a hardware accelerator, or any other suitable hardware processing circuitry, or combinations thereof. The one or more processors 502 may collectively be referred to as a processor 502.

The apparatus 500 also includes one or more memories 504 (collectively referred to as “memory 504”), which may include a volatile or non-volatile memory (e.g., a flash memory, a random-access memory (RAM), and/or a read-only memory (ROM)). The non-transitory memory 504 may store instructions for execution by the processor 502. In some embodiments, instructions 506 of a training device, such as the example training device 102 including the generative model 112, the training data generator 114, and the ML training data 116 of the example training device 102, and/or instructions for a machine learning model, such as the example machine learning models 104, 318 including the first classifier 118, 320, the second classifier 120, 322, and the optional third classifier 122, 324 if included in the machine learning model 104, 318, and/or instructions for an annotation data updating device, such as annotation data updating device including the confidence value engine 326, the data updating engine 328, the optional generative model 330 if included, and the optional formatting engine 332 if included, may be stored in the memory 504, and the instructions 506 may be executed by the processor 502 to perform the actions or operations of the methods or processes described herein.

The apparatus 500 may also include one or more network interfaces 508 for connecting to a network, such as the network 108 or 310, for communication with, for example, a database, such as the database 106 of the example system 100 or the database 306 of the example system 300, a machine learning model, such as the machine learning model 104 of the example system 100, an annotation engine, such as the annotation engine 304 of the example system 300, and/or a client device, such as the client device 308 of the example system 300.

The apparatus may optionally include a user input 510 for receiving input from a user of the apparatus 500 and a display 512. The user input 510 may be utilized, for example, for a user to interact with a graphical user interface displayed on the display 512 in order to input instructions and/or select input documents for generating annotation data and/or annotation data for updating. In this case, the instructions may be received directly from the user, via the user input 510, rather than from another device such as, for example, a client device.

In some examples, the apparatus 500 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the computing system 500) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 604 to implement data storage, retrieval, and caching functions of the apparatus 500.

The components of the apparatus 500 may communicate with each other via a bus. In some embodiments, the apparatus 500 may be a processing system implementing functionality of a training device, such as the example training device 102, a machine learning model, such as the example machine learning models 104 and 318, and/or an annotation data updating device, such as the example annotation data updating device 302. In some embodiments, the apparatus 500 may be distributed computing system and may include multiple computing devices in communication with each other over a network, as well as optionally one or more additional components. The various operations described herein may be performed by different computing devices of a distributed computing system in some embodiments. In some embodiments, the apparatus 500 may be a cloud computing system or may be a virtual machine provided by a cloud computing system.

Embodiments of the present disclosure relate to generating training data and using the generated training data training a machine learning model to assess the plausibility of annotations that are applied to text spans, particular annotations linking text in the text span to concepts form an ontology. Embodiments of the present disclosure decompose the confidence computation task into three distinct subtasks, entailing three pairwise comparisons between different aspects of a particular annotated text span input. This enables the confidence computation task to be performed in way that is agnostic to the particular method by with the annotation text span was generated, and that does not require any modifications to the process by which the annotated text span was generated. Embodiments of the present disclosure also relate to utilizing a trained machine learning model to determine a confidence value and update the annotation data to include confidence value. In some embodiments, the annotation data is filtered based on the confidence values.

Embodiments of the present disclosure provide a technical solution to the technical problem of how to generate confidence values for annotation data by providing a method and apparatus that generates confidence values that is agnostic to the process by which the annotation data was generated. Further, embodiments of the present disclosure provide a technical solution to the technical problem of how to improve the accuracy and reliability of computer systems that are utilized to analyze and process information, particularly, to LLMs that are utilized to analyze information in documents related to a particular context utilizing annotation data by providing updated annotation information that includes a determined confidence value that is related to the plausibility of the text span and the concept that is linked to the text span by the annotation. Embodiment of the present disclosure provide technical improvements to such computing systems by, for example, improving such computer system's accuracy in generating annotation data, and improving the accuracy of the analysis that is performed by utilizing the updated annotation data as disclosed herein.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

As used in the present disclosure, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (iii) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in the present disclosure, the term circuitry also covers an implementation of merely a hardware circuit or processor (or multiple processors) or portion of a hardware circuit or processor and its (or their) accompanying software and/or firmware.

The functions, processes, and operations described herein may be performed in a different order, or may be performed concurrently with each other, or a combination thereof. Furthermore, one or more of the functions, processes, and operations may be optional or may be combined. It will be appreciated that the flow diagram shown in FIG. 2 and the various embodiments described with reference to FIG. 2, are examples only. Various operations and processes depicted therein may be omitted, may be reordered, may be combined, or a combination of reordered and combined.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

What is claimed is:

1. A method of training a machine learning model, the method comprising:
for each concept of a set of concept of an ontology:
obtaining an initial sentence that includes a synonym associated with the concept;
generating, based on the initial sentence:
a first generated sentence by replacing the synonym in the initial sentence with a different synonym associated with the concept, annotating the first generated sentence as an instance of the concept;
a second generated sentence by replacing the synonym in the initial sentence with a different synonym associated with the concept and annotating the second generated sentence as an instance of a concept different than the concept;
a third generated sentence by replacing the synonym with a synonym associated with a different concept that is different than the concept and annotating the third annotated sentence as an instance of the concept;
a fourth generated sentence by replacing the synonym in the initial sentence with a synonym associated with a different concept that is different the concept and annotating the fourth generated sentence as an instance of the different concept;
a fifth generated sentence by replacing the synonym in the initial sentence with a different synonym associated with the concept and annotating the fifth generated sentence as an instance of a concept that is different than the concept;
generating, for each of the generated sentences, a first label associated with a remainder-concept plausibility, a second label associated with a synonym-concept plausibility, and third label associated with a remainder-synonym plausibility such that:
for the first generated sentence, the first, second, and third labels indicate plausible;
for the second generated sentence, the third label indicates plausible, and the first and second labels indicate implausible;
for the third generated sentence, the first label indicates plausible, and the second and third labels indicate implausible;
for the fourth generated sentence, the second label indicates plausible and the first and third labels indicate implausible; and
for the fifth generated sentence, the first, second, and third labels indicate implausible;
generating training data that comprises the generated sentences and the associated first, second, and third labels for each of the concept of the set of concepts; and
training, utilizing the training data, the machine learning model to determine the first label and the second label as plausible or implausible for an input annotated text span.

2. The method of claim 1, wherein, for each concept of the set of concepts, obtaining the initial sentence comprises:
obtaining a synonym associated with the concept from a set of synonyms associated with the concept; and
transmitting a request to a generative model to generate an example sentence that includes the obtained synonym;
receiving, from the generative model, the example sentence, wherein the received example sentence is the initial sentence.

3. The method of claim 1, wherein training the machine learning model comprises:
training a first classifier of the machine learning model to determine whether the first label of an input annotated text span is plausible or implausible; and
training a second classifier of the machine learning model to determine whether the second label of an input annotated text span is plausible or implausible.

4. The method of claim 3, wherein training the machine learning model comprises training the machine learning model to determine the third label as plausible or implausible for an input annotated text span by training a third classifier of the machine learning model to determine whether the third label of an input annotated text span is plausible or implausible.

5. The method of claim 1, wherein generating the training data comprises, for each generated sentence:
obtaining a description of the synonym included in the generated sentence;
separating the generated sentence into the synonym of the generated sentence and a remainder of the generated sentence;
generating a training data element for the generated sentence comprising the synonym, the remainder of the generated sentence, and the description of the synonym.

6. The method of claim 5, wherein the description is one of:
a definition of the synonym;
a concept identifier of the concept of the ontology that is associated with the synonym; or
a natural language name for the concept of the ontology that is associated with the synonym.

7. The method of claim 5, wherein obtaining the description comprises:
instructing a generative machine learning model to:
generate a description or definition of the synonym, or
generate a description or definition of a natural language name of a concept that is associated with the synonym; and
receiving, from the generative machine learning model, the generated description or definition.

8. The method of claim 5, wherein generating the training data element for the generated sentence comprises:
replacing the synonym in the remainder with a mask token;
inserting delimitators between the remainder, the synonym, and the description to generate a templated training data element; and
generating, utilizing an embedding function, a vector representation of the templated training data element.

9. The method of claim 5, wherein generating the training data element for the generated sentence comprises:
generating, utilizing an embedding function:
a first vector representation of the remainder;
a second vector representation of the synonym; and
a third vector representation of the description;
wherein training the machine learning model comprises:
training a first classifier of the machine learning model to determine whether the first label of an input annotated text span is plausible or implausible utilizing only the first and third vector representations of the training data; and
training a second classifier of the machine learning model to determine whether the second label of an input annotated text span is plausible or implausible utilizing only the second and third vector representations of the training data.

10. The method of claim 9, wherein training the machine learning model further comprises:
training a third classifier of the machine learning model to determine whether the third label of an input annotated text span is plausible or implausible utilizing only the first and second vector representations of the training data.

11. A method for a machine learning system, the method comprising:
obtaining annotation data that includes one or more annotated text spans, each annotation text span including a text span and a description, the text span including annotated text and a remainder comprising text of the text span other than annotated text, wherein the description is associated with a concept of an ontology that is linked to the annotated text;
for each of the one or more annotated text spans:
inputting the annotated text span into a machine learning model, the machine learning model comprising:
a first classifier trained to generate a first value that indicates a first label of the text span a plausible or implausible, the first label associated with plausibility between the remainder of the text span and the description; and
a second classifier trained to generate a second value that indicates a likelihood of a second label of the text span being plausible, the second label associated with a plausibility between the annotated text and the description;
receiving, from the machine learning model, the first value and the second value;
determining, based on the first value and the second value, a confidence value associated of the annotated text span; and
updating the annotation data to include the confidence value for the annotated text span.

12. The method of claim 11, wherein the machine learning model further comprises:
a third classifier trained to generate a third value that indicates a likelihood of a third label of the text span being plausible, the third label associated with a plausibility between the remainder and the annotated text;
the method further comprising receiving the third value and the third accuracy value.

13. The method of claim 11, further comprising:
replacing the annotated text in the text span with a mask token;
generating a templated text span that includes the remainder, the mask token, the annotated text, and the description separated by delimiters; and
generating, utilizing an embedding function, a vector representation of the templated text span;
wherein inputting the obtained text span into the machine learning model comprises inputting the vector representation.

14. The method of claim 11, further comprising:
generating, utilizing an embedding function:
a first vector representation of the remainder of the text span;
a second vector representation of the annotated text; and
a third vector representation of the description;
wherein inputting the annotated text span into the machine learning model comprises inputting the first, second, and third vector representations; and
wherein the first classifier is trained to generate the first value based on the first and third vector representations, and the second classifier is trained to generate the second value based on the second and third vector representations.

15. The method of claim 14, wherein the machine learning model further comprises:
a third classifier trained to generate a third value based on the first and second vector representations, the third value indicates a likelihood of a third label of the text span being plausible, the third label associated with a plausibility between the remainder and the annotated text;
the method further comprising receiving the third value.

16. The method of claim 11, wherein determining the confidence value based on the first value and the second value comprises weighing the first and second values.

17. A machine learning engine comprising:
a processor;
a memory storing processor executable instructions for a machine learning model executable by the processor to cause the processor to perform operations comprising:
obtaining an initial sentence that includes a synonym associated with the concept;
generating, based on the initial sentence:
a first generated sentence by replacing the synonym in the initial sentence with a different synonym associated with the concept, annotating the first generated sentence as an instance of the concept;
a second generated sentence by replacing the synonym in the initial sentence with a different synonym associated with the concept and annotating the second generated sentence as an instance of a concept different than the concept;
a third generated sentence by replacing the synonym with a synonym associated with a different concept that is different than the concept and annotating the third annotated sentence as an instance of the concept;
a fourth generated sentence by replacing the synonym in the initial sentence with a synonym associated with a different concept that is different the concept and annotating the fourth generated sentence as an instance of the different concept;
a fifth generated sentence by replacing the synonym in the initial sentence with a different synonym associated with the concept and annotating the fifth generated sentence as an instance of a concept that is different than the concept;
generating, for each of the generated sentences, a first label associated with a remainder-concept plausibility, a second label associated with a synonym-concept plausibility, and third label associated with a remainder-synonym plausibility such that:
for the first generated sentence, the first, second, and third labels indicate plausible;
for the second generated sentence, the third label indicates plausible, and the first and second labels indicate implausible;
for the third generated sentence, the first label indicates plausible, and the second and third labels indicate implausible;
for the fourth generated sentence, the second label indicates plausible and the first and third labels indicate implausible; and
for the fifth generated sentence, the first, second, and third labels indicate implausible;
generating training data that comprises the generated sentences and the associated first, second, and third labels for each of the concept of the set of concepts; and
training, utilizing the training data, the machine learning model to determine the first label and the second label as plausible or implausible for an input annotated text span.

18. An apparatus for training a machine learning model, the apparatus comprising:
a processor;
a memory storing processor executable instructions executable by the processor to cause the process to:
for each concept of a set of concept of an ontology:
obtain an initial sentence that includes a synonym associated with the concept;
generate, based on the initial sentence:
a first generated sentence by replacing the synonym in the initial sentence with a different synonym associated with the concept, annotating the first generated sentence as an instance of the concept;
a second generated sentence by replacing the synonym in the initial sentence with a different synonym associated with the concept and annotating the second generated sentence as an instance of a concept different than the concept;
a third generated sentence by replacing the synonym with a synonym associated with a different concept that is different than the concept and annotating the third annotated sentence as an instance of the concept;
a fourth generated sentence by replacing the synonym in the initial sentence with a synonym associated with a different concept that is different the concept and annotating the fourth generated sentence as an instance of the different concept;
a fifth generated sentence by replacing the synonym in the initial sentence with a different synonym associated with the concept and annotating the fifth generated sentence as an instance of a concept that is different than the concept;
generate, for each of the generated sentences, a first label associated with a remainder-concept plausibility, a second label associated with a synonym-concept plausibility, and third label associated with a remainder-synonym plausibility such that:
for the first generated sentence, the first, second, and third labels indicate plausible;
for the second generated sentence, the third label indicates plausible, and the first and second labels indicate implausible;
for the third generated sentence, the first label indicates plausible, and the second and third labels indicate implausible;
for the fourth generated sentence, the second label indicates plausible and the first and third labels indicate implausible; and
for the fifth generated sentence, the first, second, and third labels indicate implausible;
generate training data that comprises the generated sentences and the associated first, second, and third labels for each of the concept of the set of concepts; and
train, utilizing the training data, the machine learning model to determine the first label and the second label as plausible or implausible for an input annotated text span.

19. The apparatus of claim 18, wherein, for each concept of the set of concepts, the instructions to cause the processor to obtain the initial sentence comprises instructions that, when executed by the processor, cause the processor to:
obtain a synonym associated with the concept from a set of synonyms associated with the concept; and
transmit a request to a generative model to generate an example sentence that includes the obtained synonym;
receive, from the generative model, the example sentence, wherein the received example sentence is the initial sentence.

20. The apparatus of claim 18, wherein the instructions to cause the processor to train the machine learning model comprises instructions that, when executed by the processor, cause the processor to:
train a first classifier of the machine learning model to determine whether the first label of an input annotated text span is plausible or implausible; and
train a second classifier of the machine learning model to determine whether the second label of an input annotated text span is plausible or implausible.

21. The apparatus of claim 20, wherein the instructions to cause the processor to train the machine learning model comprises instructions that, when executed by the processor, cause the processor to train the machine learning model to determine the third label as plausible or implausible for an input annotated text span by training a third classifier of the machine learning model to determine whether the third label of an input annotated text span is plausible or implausible.

22. The apparatus of claim 18, wherein the instructions to cause the processor to generate the training data comprises instructions that, when executed by the processor, cause the process to, for each generated sentence:
obtain a description of the synonym included in the generated sentence;
separate the generated sentence into the synonym of the generated sentence and a remainder of the generated sentence;
generate a training data element for the generated sentence comprising the synonym, the remainder of the generated sentence, and the description of the synonym.

23. The apparatus of claim 22, wherein the description is one of:
a definition of the synonym;
a concept identifier of the concept of the ontology that is associated with the synonym; or
a natural language name for the concept of the ontology that is associated with the synonym.

24. The apparatus of claim 22, wherein the instructions to cause the processor to obtain the description comprises instructions that, when executed by the processor, causes the processor to:
instruct a generative machine learning model to:
generate a description or definition of the synonym, or
generate a description or definition of a natural language name of a concept that is associated with the synonym; and
receive, from the generative machine learning model, the generated description or definition.

25. The apparatus of claim 22, wherein the instruction to cause the processor to generate the training data element for the generated sentence comprises instructions that, when executed by the processor, cause the processor to:
replace the synonym in the remainder with a mask token;
insert delimitators between the remainder, the synonym, and the description to generate a templated training data element; and
generate, utilizing an embedding function, a vector representation of the templated training data element.

26. The apparatus of claim 22, wherein the instruction to cause the processor to generate the training data element for the generated sentence comprises instructions that, when executed by the processor, cause the processor to:
generate, utilizing an embedding function:
a first vector representation of the remainder;
a second vector representation of the synonym; and
a third vector representation of the description;
wherein the instructions to cause the processor to train the machine learning model comprises instructions that, when executed by the processor, cause the processor to:
train a first classifier of the machine learning model to determine whether the first label of an input annotated text span is plausible or implausible utilizing only the first and third vector representations of the training data; and
train a second classifier of the machine learning model to determine whether the second label of an input annotated text span is plausible or implausible utilizing only the second and third vector representations of the training data.

27. The apparatus of claim 26, the instructions to cause the processor to train the machine learning model comprises instructions that, when executed by the processor, further cause the processor to:
train a third classifier of the machine learning model to determine whether the third label of an input annotated text span is plausible or implausible utilizing only the first and second vector representations of the training data.

28. An apparatus comprising:
a processor;
a memory storing processor executable instructions executable by the processor to cause the process to:
obtain annotation data that includes one or more annotated text spans, each annotation text span including a text span and a description, the text span including annotated text and a remainder comprising text of the text span other than annotated text, wherein the description is associated with a concept of an ontology that is linked to the annotated text;
for each of the one or more annotated text spans:
input the annotated text span into a machine learning model, the machine learning model comprising:
a first classifier trained to generate a first value that indicates a first label of the text span a plausible or implausible, the first label associated with plausibility between the remainder of the text span and the description; and
a second classifier trained to generate a second value that indicates a likelihood of a second label of the text span being plausible, the second label associated with a plausibility between the annotated text and the description;
receive, from the machine learning model, the first value and the second value;
determine, based on the first value and the second value, a confidence value associated of the annotated text span; and
update the annotation data to include the confidence value for the annotated text span.

29. The apparatus of claim 28, wherein the machine learning model further comprises:
a third classifier trained to generate a third value that indicates a likelihood of a third label of the text span being plausible, the third label associated with a plausibility between the remainder and the annotated text;
the instructions further comprising instructions that, when executed by the processor, cause the processor to receive the third value and the third accuracy value.

30. The apparatus of claim 28, the instructions further comprising instructions that, when executed by the processor, cause the processor to:
replace the annotated text in the text span with a mask token;
generate a templated text span that includes the remainder, the mask token, the annotated text, and the description separated by delimiters; and
generate, utilizing an embedding function, a vector representation of the templated text span;
wherein the instructions to cause the processor to input the obtained text span into the machine learning model comprises instructions that, when executed by the processor, cause the processor to input the vector representation.

31. The method of claim 28, the instructions further comprising instructions that, when executed by the processor, cause the processor to:
generate, utilizing an embedding function:
a first vector representation of the remainder of the text span;
a second vector representation of the annotated text; and
a third vector representation of the description;
wherein the instructions that cause the processor to input the annotated text span into the machine learning model comprises instructions that, when executed by the processor, cause the processor to input the first, second, and third vector representations; and
wherein the first classifier is trained to generate the first value based on the first and third vector representations, and the second classifier is trained to generate the second value based on the second and third vector representations.

32. The apparatus of claim 31, wherein the machine learning model further comprises:
a third classifier trained to generate a third value based on the first and second vector representations, the third value indicates a likelihood of a third label of the text span being plausible, the third label associated with a plausibility between the remainder and the annotated text;
the instructions further comprising instructions that, when executed by the processor, cause the processor to receive the third value.

33. The apparatus of claim 28, wherein the instruction that cause the processor to determine the confidence value based on the first value and the second value comprises instructions that, when executed by the processor, cause the processor to weigh the first and second values.
